(19) United States
(12) Patent Application Publication
(10) Pub. No.: US 2014/0013179 A1
(43) Pub. Date: Jan. 9, 2014

(54) TRANSMISSION DELAY DIFFERENCE CORRECTION METHOD, COMMUNICATION DEVICE, AND COMMUNICATION SYSTEM

(71) Applicant: FUJITSU LIMITED, KAWASAKI-SHI (JP)

(72) Inventor: Kazuya TAKAKU, Kawasaki (JP)

(73) Assignee: FUJITSU LIMITED, KAWASAKI-SHI (JP)

(21) Appl. No.: 14/026,619

(22) Filed: Sep. 13, 2013

Related U.S. Application Data
(63) Continuation of application No. PCT/JP2011/056601, filed on Mar. 18, 2011.

(51) Int. Cl. H04L 1/00

(52) U.S. Cl. CPC H04L 1/0045
USPC 714/748

(57) ABSTRACT

Two neighboring receiving units that receive a same signal notify each other of information representing that the signal has been received through the signal line, a process of correcting a transmission delay difference is performed according to a time difference between notification from the other receiving unit and its own signal reception, and selection of one of the neighboring receiving units and a receiving unit that has not performed a correction process with the one receiving unit among receiving units neighboring to the one receiving unit and a transmission delay difference correction process between the selected receiving units are sequentially performed. Thus, even when the number of processing target lanes increases, a transmission delay difference can be reliably absorbed and corrected while implementing an interconnection layout, a noise counter-measure, and a high-speed circuit.

### CROSS-REFERENCE TO RELATED APPLICATION

This application is a continuation application of International Application No. PCT/JP2011/056601 filed on Mar. 18, 2011 in Japan and designated the U.S., the entire contents of which are hereby incorporated by reference.

### FIELD

The present invention relates to a transmission delay difference correction method, a communication device, and a communication system.

### BACKGROUND

Generally, inside a device such as a server, transmission of multi-bit parallel data is performed between a transmitting module and a receiving module. When the multi-bit parallel data is transmitted in parallel through as many signal lines as the number of bits, a transmission delay difference (skew) occurs between the signal lines, for example, due to a difference in a transmission path length. For this reason, when a transmission delay difference does not fall within a period of a reception side clock, a transmission delay difference of data transmitted through each signal line needs to be absorbed so that the multi-bit parallel data can be received at the same timing in the receiving module. Thus, when the number of bits of parallel data increases, a process of absorbing a transmission delay difference needs to be performed on many signal lines. Hereinafter, the wording “absorb” means correction performed such that the transmission delay difference is removed.

In this regard, the transmission side divides the multi-bit parallel data into a plurality of pieces of partial data, and transmits each of a plurality of pieces of divided partial data from the transmission side to the reception side as serial data through a plurality of lanes installed in parallel between the transmission side and the reception side. Even in this case, a transmission delay difference (skew) occurs between lanes, for example, due to a difference in a transmission path length. For this reason, when a transmission delay difference does not fall within a period of a reception side clock, a transmission delay difference of data transmitted through each lane needs to be absorbed so that data transmitted through a plurality of lanes can be received at the same timing in the receiving side.

However, when partial data is transferred, since a process of absorbing a transmission delay difference is performed on each of lanes which are smaller in number than the number of bits of parallel data, a processing amount is significantly reduced compared to a case where a process of absorbing a transmission delay difference is performed on as many signal lines as the number of bits. For example, when 64-bit parallel data is transmitted from the transmission side to the reception side through 8 lanes, the 64-bit parallel data is divided into 8 sets of 8-bit data, each 8-bit data is subjected to parallel/serial conversion, and serial data is transmitted through each lane. Thus, only by performing a process of absorbing a transmission delay difference on 8 lanes instead of performing a process of absorbing a transmission delay difference on as many signal lines as 64 bits, the 64-bit parallel data is received at the reception side at the same timing.

More specifically, in a device 100 such as a server with a data transmission function illustrated in FIG. 38, transmission of multi-bit (for example, 64-bit) parallel data is performed between a transmitting module 110 and a receiving module 120. At this time, the transmitting module 110 divides the multi-bit parallel data into a plurality of pieces of partial data. Each of the plurality of pieces of divided partial data is transmitted from the transmitting module 110 to the receiving module 120 as serial data through n+1 (n is a natural number) lanes [0] to [n] installed in parallel between the transmitting module 110 and the receiving module 120. Then, the receiving module 120 reconstructs the multi-bit parallel data from the plurality of pieces of partial data.

Each lane [i] (i=0 to n) includes a lane [i] transmitting unit 110-i, a lane [i] receiving unit 120-i, and a lane [i] transmission path 130-i. Further, transmitting units 110-1 to 110-n are included in the transmitting module 110, and receiving units 120-1 to 120-n are included in the receiving module 120.

Each transmitting unit 110-i performs parallel/serial conversion on the divided partial data (for example, 8-bit data), and transmits serial data to the transmission path 130-i.

Each transmission path 130-i transmits the serial data transmitted from the transmitting unit 110-i to the receiving unit 120-i through a serial transmission path represented by a Peripheral Component Interconnect (PCI) Express.

Each receiving unit 120-i performs serial/parallel conversion on the serial data received from the transmission path 130-i, and reconstructs partial data as will be described later with reference to FIG. 39. In each receiving unit 120-i, a transmission delay difference of each lane [i] is absorbed by an inter-lane transmission delay difference absorbing buffer 124 (which will be described later) in which a read-out position of data is set in advance. Then, the multi-bit parallel data is reconstructed from the partial data in which a transmission delay difference is absorbed.

Next, configurations of the receiving module 120 and each lane [i] receiving unit 120-i of the device 100 illustrated in FIG. 38 will be described with reference to FIG. 39. Note that, FIG. 39 illustrates only a detailed configuration of the lane [0] receiving unit 120-0, but each lane [i] receiving unit 120-i has the same configuration as the lane [0] receiving unit 120-0. Further, FIG. 39 illustrates an example in which n is 7, that is, the number of lanes (the number of transmission paths) is 8.

The receiving module 120 includes an inter-lane transmission delay difference absorption control circuit (hereinafter, referred to simply as a “control circuit”) 120a and a processing module 120b in addition to the receiving units 120-0 to 120-7 as illustrated in FIG. 39. Each receiving unit 120-i includes a serial/parallel (S/P) converting circuit 121, a bit boundary detecting circuit 122, a clock transfer buffer 123, an inter-lane transmission delay difference absorbing buffer (hereinafter, referred to simply as a “buffer”) 124, and a pattern detecting circuit 125.

The control circuit 120a is connected to the receiving units 120-0 to 120-7 (the pattern detecting circuit 125) through signal lines SL0 to SL7, and controls a setting process of absorbing a transmission delay difference between each pair of lanes [0] to [7] in collaboration with the receiving units 120-0 to 120-7. The details of a function of the control circuit 120a will be described later.

The processing module 120b performs a process such as protocol check on parallel data reconstructed form partial data obtained by the receiving units 120-0 to 120-n.

The S/P converting circuit (DeSerializer) 121 converts the serial data received from the transmission path 130-i into 8-bit parallel data (8-bit data).

The bit boundary detecting circuit 122 compares 8-bit data from the S/P converting circuit 121 with a boundary detection pattern previously decided between the transmission side and the reception side, and detects 8-bit data having the same pattern as the boundary detection pattern as 8-bit head data. The 8-bit head data detected by the bit boundary detecting circuit 122 is an accurate separation position, that is, a bit boundary (byte boundary) of each 8-bit data. When the bit boundary is detected, the bit boundary detecting circuit 122 generates a write enable signal for writing the 8-bit data in the clock transfer buffer 123 at the detection timing, and outputs the write enable signal to the clock transfer buffer 123. The serial data received from the transmission path 130-i is converted into meaningful 8-bit data through the S/P converting circuit 121 and the bit boundary detecting circuit 122.

Upon receiving the write enable signal, the clock transfer buffer 123 sequentially writes the 8-bit data and temporarily holds the 8-bit data, and thus absorbs a clock frequency difference between the transmitting module 110 and the receiving module 120. The 8-bit data held in the clock transfer buffer 123 is sequentially read out according to a clock of the receiving module 120.

The buffer 124 temporarily holds the 8-bit data received from the clock transfer buffer 123, and absorbs a transmission delay difference between each pair of the lanes [0] to [7]. The holding period of time (read-out position) of the 8-bit data by the buffer 124 is adjusted and set during an initialization period of time through the pattern detecting circuit 125 and the control circuit 120a as will be described later. Note that, the buffer 124 has a buffer stage number capable of absorbing a maximum transmission delay difference predicted based on design information of a transmission path.

The pattern detecting circuit 125 has a function of determining whether the 8-bit data is a specific pattern by comparing the 8-bit data read from the clock transfer buffer 123 with a specific pattern previously decided between the transmission side and the reception side. The pattern detecting circuit 125 has a function of notifying the control circuit 120a of a pattern detection signal through a signal line SLi when it is detected that the 8-bit data is the specific pattern.

The pattern detecting circuit 125 further has a counter function of detecting a transmission delay difference of a lane [i].

The counter function detects the transmission delay difference of the lane [i] as a count value by starting an increment at a detection timing of a specific pattern according to a clock signal and stopping an increment according to a stop signal (which will be described later) from the control circuit 120a. The pattern detecting circuit 125 further has a function of setting a read-out position (a read-out timing) of the 8-bit data from the buffer 124 in the lane [i] based on the transmission delay difference of the lane [i] detected by the counter function.

The control circuit 120a is connected the receiving units 120-0 to 120-7 through the signal lines SL0 to SL7 as described above, and receives a pattern detection signal from the pattern detecting circuit 125 of each receiving unit 120-i through the signal line SLi. Further, the control circuit 120a transmits the stop signal to the pattern detecting circuit 125 of each receiving unit 120-i through the signal line SLi at a timing that a logical product (AND) of the received pattern detection signals becomes “1”, that is, a timing at which the pattern detection signals are received from the pattern detecting circuit 125 of all the receiving units 120-0 to 120-7.

The device 100 having the above-described configuration performs a setting process of absorbing a transmission delay difference between each pair of the lanes [0] to [7] as follows.

The transmitting module 110 and the receiving module 120 include a circuit (not illustrated) of performing initialization of synchronizing the modules 110 and 120 with each other as an initialization state machine. The initialization state machine causes the transmitting module 110 and the receiving module 120 to be synchronized with each other such that the transmission side transmits a specific pattern during an initialization period of time in which the device 100 is activated, and the reception side recognizes reception of the specific pattern. The setting process of absorbing a transmission delay difference between each pair of the lanes [0] to [7] is also performed within the initialization period of time.

When the setting process of absorbing a transmission delay difference between each pair of the lanes [0] to [7] is performed, first of all, data including a specific pattern is transmitted from the transmitting module 110 to all the lanes [0] to [7]. In the receiving module 120, the initialization state machine causes the receiving units 120-0 to 120-7 to enter an enable state at the same time, and each receiving unit 120-i receives the data including the specific pattern.

When it is detected that the received 8-bit data (see Reference Numeral s1 in FIG. 39) is a specific pattern, the pattern detecting circuit 125 of each receiving unit 120-i starts an increment by the counter function. At the same time, the pattern detecting circuit 125 transmits the pattern detection signal to the control circuit 120a through the signal line SLi.

The pattern detection signals (see Reference Numeral s2 in FIG. 39) from the pattern detecting circuits 125 in all the lanes [0] to [7] are collected in the single control circuit 120a shared by all the lanes [0] to [7]. The control circuit 120a transmits the stop signal (see Reference Numeral s3 in FIG. 39) to the pattern detecting circuit 125 of each receiving unit 120-i through the signal line SLi at a timing at which the pattern detection signals are received from the pattern detecting circuits 125 of all the lanes [0] to [7].

Upon receiving the stop signal from the control circuit 120a, the pattern detecting circuit 125 of each receiving unit 120-i stops an increment by the counter function, and acquires a count value at the time of stop as the transmission delay difference of the lane [i].

At this time, when there is no transmission delay difference between each pair of all the lanes [0] to [7], the count values counted by the counter functions of all the lanes [0] to [7] become the same value. However, when there is a transmission delay difference between each pair of the lanes [0] to [7], a count value of a lane in which a specific pattern is detected at an earlier timing is larger than count values of the other lanes. Meanwhile, a count value of a lane in which a specific pattern is detected at a late timing is smaller than count values of the other lanes. The count value is set by the pattern detecting circuit 125 as a data read-out start position (an initial value of a read pointer) from the buffer 124 of each lane [i] (see Reference Numeral s4 in FIG. 39).

Thus, in a lane in which a specific pattern is detected at an early timing, data is read from a deep position of the buffer 124, and in a lane in which a specific pattern is detected at a late timing, data is read from a shallow position of the buffer 124. As a result, a transmission delay difference between each pair of all the lanes [0] to [7] is absorbed.

In other words, in order to offset the transmission delay difference of each lane [i], the pattern detecting circuit 125 of each lane [i] adjusts a data read stage number of the buffer 124 according to a data read-out timing of the buffer 124 in a lane in which a transmission delay difference is largest. Since the data read stage number of the buffer 124 depends on a difference in a transmission path length of each lane [i], when the data read stage number of the buffer 124 is decided within the initialization period of time, the initialization period of time is fixed without needing to be changed.

The pattern detection signals s2 from the receiving units 120-0 to 120-7 of all the lanes [0] to [7] are collected in the single control circuit 120a serving as a unit common to all the lanes [0] to [7] through the signal lines SL0 to SL7 as illustrated in FIG. 39. Further, the stop signal s3 is transferred from the single control circuit 120a to the receiving units 120-0 to 120-7 of all the lanes [0] to [7] through the signal lines SL0 to SL7. For this reason, a problem occurs as follows.

An information amount of the pattern detection signal from each lane [i] is 1 bit and thus small. However, the control circuit 120a collects at least as many signal lines as the number of lanes. For this reason, when the number of lanes increases, it is very difficult to make an interconnection layout or take noise counter-measure between each lane [i] and the control circuit 120a.

Further, when the number of lanes increases, there is a lane arranged at the position physically distant from the control circuit 120a. Since the setting process of absorbing a transmission delay difference is performed while acquiring synchronization of all lanes including the lane arranged at the distant position, it is difficult to increase an operation frequency of a circuit. In other words, at the time of the setting process of absorbing a transmission delay difference, when there is a lane physically distant from the control circuit 120a and the speed of a circuit increases, it is difficult to exchange the pattern detection signal s2 or the stop signal s3 between the control circuit 120a and the distant lane using a single clock.

As described above, in the device 100 illustrated in FIG. 39, since pieces of information from a plurality of lanes are collected in the single control circuit 120a, when the number of lanes of a transmission delay difference absorption process target increases, it is difficult to make a circuit in terms of an interconnection layout of a signal line, a noise counter-measure, and an operation frequency of a circuit.
[Patent Literature 1] Japanese Laid-open Patent Publication No. 2009-219097
[Patent Literature 2] Japanese Laid-open Patent Publication No. 2004-289567

### SUMMARY

A transmission delay difference correction method of the present disclosure is a transmission delay difference correction method of correcting a transmission delay difference in a plurality of transmission paths in a communication device that includes a plurality of receiving units each corresponding to one of the plurality of transmission paths and that receives data from a transmission side device through the plurality of transmission paths, wherein each of the plurality of receiving units is connected to each neighboring receiving unit via a signal line, and includes at two neighboring receiving units among the plurality of receiving units, the two neighboring receiving units receiving a same signal, upon receipt of the same signal at each neighboring receiving unit, notifying the other neighboring receiving unit of the receipt of the same signal through the signal line, at the each neighboring receiving unit, performing a process of correcting the transmission delay difference according to a time difference between notification of the receipt of the same signal from the other neighboring receiving unit and the receipt of the same signal at the each neighboring receiving unit, performing a process of selecting, as next two neighboring receiving units, one of the two neighboring receiving units and a receiving unit, neighboring to the one receiving unit, that has not performed the process of correcting with the one receiving unit, among the plurality of receiving units, and performing the process of correcting for the selected next two neighboring receiving units.

Further, a communication device of the present disclosure is a communication device that is connected to a transmitting device through a plurality of transmission paths and that receives information from the transmitting device through the plurality of transmission paths, and includes a plurality of receiving units each of which is provided for each transmission path, and a signal line that connects each of the plurality of receiving units to each neighboring receiving unit, wherein each of the plurality of receiving units includes a detecting unit that detects a signal received through a corresponding transmission path of the plurality of transmission paths, and transfers and receives a detection result of the signal to and from a neighboring receiving unit to each receiving unit of the plurality of receiving units through the signal line, and a control unit that performs control such that a transmission delay difference between each receiving unit and the neighboring receiving unit is corrected based on a detection time difference between a timing of detecting the signal at the neighboring receiving unit and a timing of detecting the signal at each receiving unit, and the control unit notifies the neighboring receiving unit of a state of a process of correcting at each receiving unit, and when the control unit has not performed the process of correcting, the control unit starts the process of correcting in response to notification of the state of the process of correcting from the neighboring receiving unit.

Further, a communication system of the present disclosure includes a communication device that is connected to the transmitting device through a plurality of transmission paths and that receives information from the transmitting device through the plurality of transmission paths, and the communication device has the same configuration as the above-described communication device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram illustrating a configuration of a device (communication system) with a data transmission function according to an embodiment;

FIG. 2 is a block diagram illustrating configurations of a receiving module (communication device) including a transmission delay difference absorbing device according to the present embodiment and each lane receiving unit;

FIG. 3 is a block diagram illustrating main components of a receiving module (communication device) including a transmission delay difference absorbing device according to the present embodiment and an interconnection state of signal lines between lanes;

FIG. 4 is a block diagram illustrating a configuration of a pattern detecting circuit and a configuration of an inter-lane transmission delay difference absorption control circuit according to the present embodiment;

FIG. 5 is a block diagram illustrating a configuration of an inter-lane transmission delay difference absorbing buffer and a configuration of a transmission delay difference absorption setting unit in an inter-lane transmission delay difference absorption control circuit according to the present embodiment;

FIG. 6 is a block diagram illustrating a configuration of a lane control unit in an inter-lane transmission delay difference absorption control circuit according to the present embodiment;

FIG. 7 is a diagram illustrating a logic (truth table) of first and second decoders illustrated in FIG. 6;

FIG. 8 is a diagram illustrating a logic (truth table) of a third decoder illustrated in FIG. 6;

FIG. 9 is a flowchart for describing an inter-lane transmission delay difference absorption setting process (correction process) performed by a transmission delay difference absorbing device (communication device) according to the present embodiment;

FIGS. 10A to 10F are diagrams for describing an inter-lane transmission delay difference absorption setting process (correction process) performed by a transmission delay difference absorbing device according to the present embodiment;

FIGS. 11 to 37 are diagrams for describing lane pair selection operations (1) to (27) in a transmission delay difference absorbing device according to the present embodiment;

FIG. 38 is a block diagram illustrating a configuration of a device with a data transmission function; and

FIG. 39 is a block diagram illustrating configurations of a receiving module and each lane receiving unit of the device illustrated in FIG. 38.

### DESCRIPTION OF THE PREFERRED EMBODIMENTS

Hereinafter, an exemplary embodiment will be described with reference to the accompanying drawings.

[1] Configuration of Transmission Delay Difference Absorbing Device (Communication Device)

[1-1] Configuration of Device (Communication System) to Which Transmission Delay Difference Absorbing Device (Communication Device) is Applied

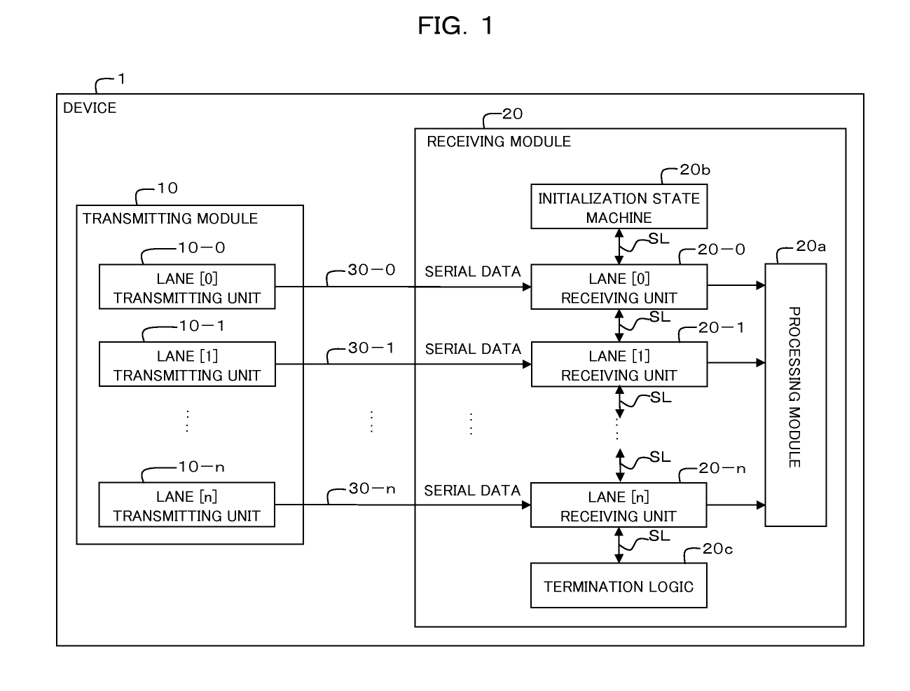

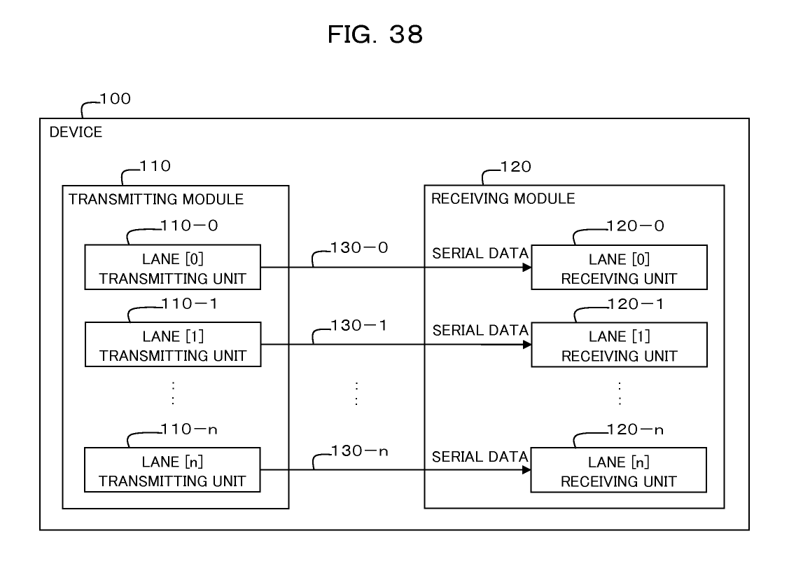

FIG. 1 is a block diagram illustrating a configuration of a device (communication system) 1 with a data transmission function according to an embodiment. In the device 1 according to the present embodiment, similarly to the device 100 illustrated in FIG. 38, transmission of multi-bit (for example, 64-bit) parallel data is performed between a transmitting module (a transmission side or a transmitting device) 10 and a receiving module (a reception side or a communication device) 20 as illustrated in FIG. 1. At this time, the transmitting module 10 divides the multi-bit parallel data into a plurality of pieces of partial data. The plurality of pieces of divided partial data are transmitted from the transmitting module 10 to the receiving module 20 as serial data through n+1 (n is a natural number) lanes [0] to [n] installed in parallel between the transmitting module 10 and the receiving module 20, respectively. Then, the receiving module 20 reconstructs the multi-bit parallel data from the plurality of pieces of partial data.

Each lane [i] (i=0 to n) includes a lane [i] transmitting unit 10-i, a lane [i] receiving unit 20-i, and a lane [i] transmission path 30-i. The transmitting units 10-1 to 10-n are included in the transmitting module 10, and the receiving units 20-1 to 20-n are included in the receiving module 20 together with a processing module 20a, an initialization state machine 20b, and a termination logic 20c.

Each transmitting unit 10-i performs parallel/serial conversion on the divided partial data (for example, 8-bit data) and transmits serial data to a transmission path 30-i.

Each transmission path 30-i transmits the serial data transmitted from the transmitting units 10-i to the receiving unit 20-i through a serial transmission path represented by the PCI Express.

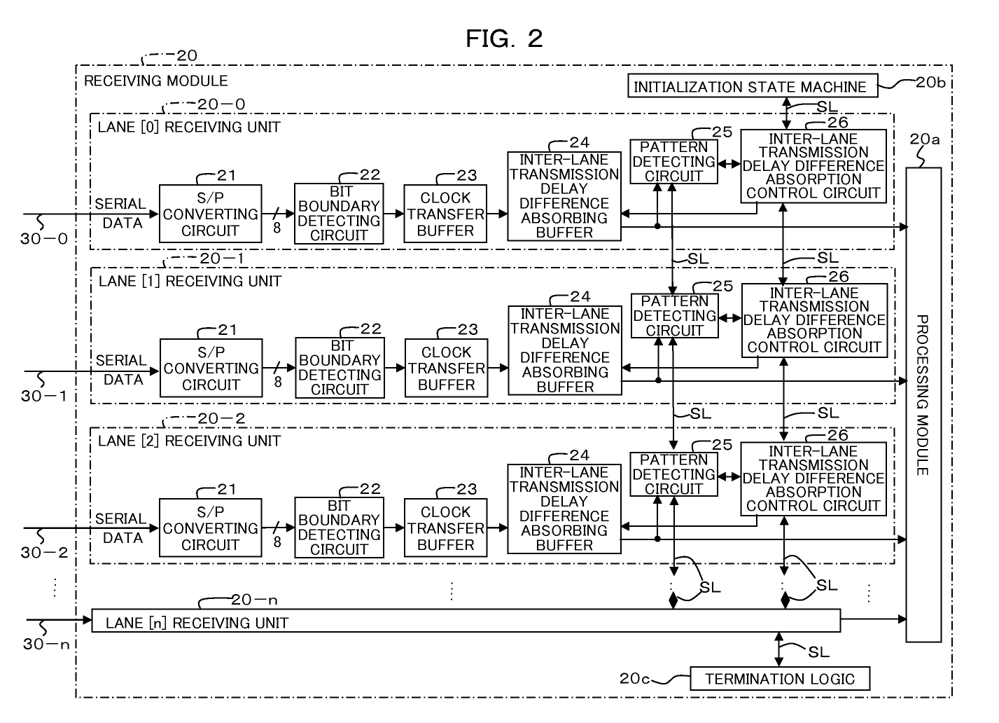

Each receiving unit 20-i performs serial/parallel conversion on the serial data received from the transmission path 30-i and reconstructs partial data as will be described later with reference to FIG. 2. Each receiving unit 20-i corrects a transmission delay difference of each lane [i] through an inter-lane transmission delay difference absorbing buffer 24 (which will be described later) to which a read-out position of data is set in advance. Then, the multi-bit parallel data is reconstructed from the partial data in which the transmission delay difference is corrected. Each receiving unit 20-i is connected to the processing module 20a, and the processing module 20a performs a process such as a protocol check on the parallel data reconstructed from the partial data.

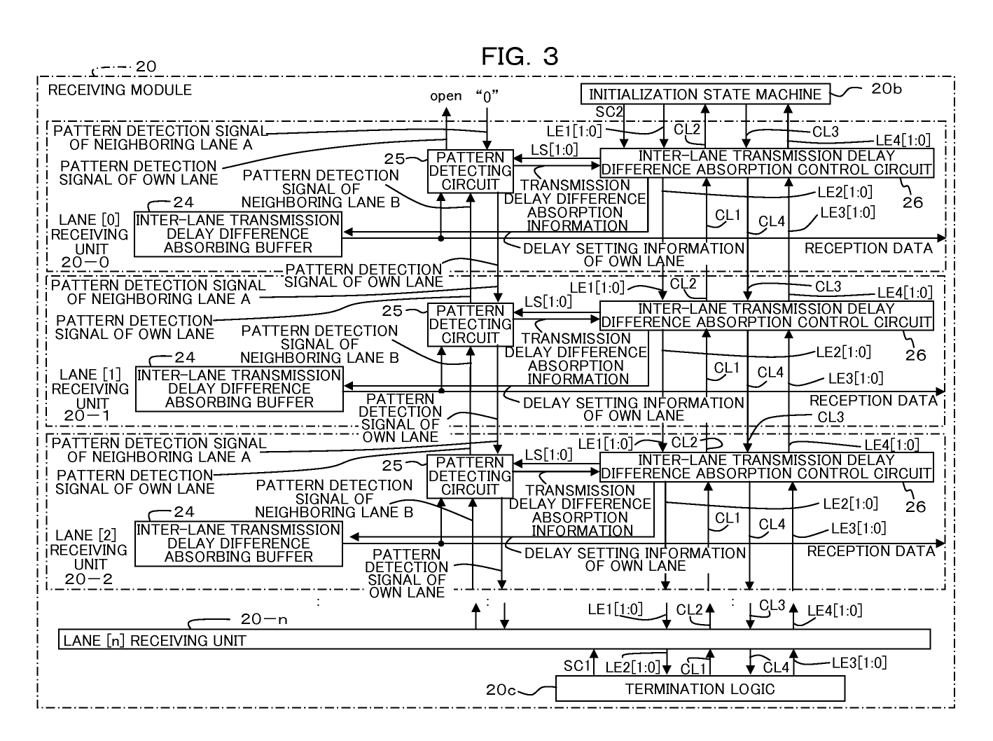

In the plurality of lanes [0] to [n], neighboring lanes [i] and [i+1] (or [i−1] and [i]) are connected to each other through a signal line SL, and information (which will be described later) related to the setting process (correction process) of absorbing a transmission delay difference can be exchanged between the neighboring lanes. Specifically, a pattern detecting circuit 25 and an inter-lane transmission delay difference absorption control circuit 26 of the receiving unit 20-i are connected to the pattern detecting circuit 25 and the inter-lane transmission delay difference absorption control circuit 26 of the receiving unit 20-(i+1) through the signal line SL as will be described later with reference to FIGS. 2 and 3.

Note that, the initialization state machine 20b is connected to the lane [0] of one end through the signal line SL. The initialization state machine 20b has a function of performing initialization for causing the transmitting module 10 and the receiving module 20 to operate in synchronization with each other and performing a start process and an end process of lane pair selection on the lane [0] which will be described later. Further, the lane [n] of the other end is connected to the termination logic 20c through the signal line SL. The termination logic 20c is a logical circuit that causes the lane [n] to perform a turn-back operation of lane pair selection which will be described later. Concrete functions and operations of the initialization state machine 20b and the termination logic 20c will be described below with reference to FIGS. 2, 3 and 11 to 37.

[1-2] Outline of Transmission Delay Difference Absorbing Device (Communication Device)

Each receiving unit 20-i includes an absorption processing unit (control unit) that includes the inter-lane transmission delay difference absorbing buffer 24, the pattern detecting circuit 25, and the inter-lane transmission delay difference absorption control circuit 26 which will be described below with reference to FIGS. 2 to 6. The absorption processing unit has a function of sequentially shift-selecting two neighboring lanes from among the plurality of lanes [0] to [n]. Further, each time two lanes are selected, the absorption processing unit exchanges information (which will be described later) related to a correction setting process (correction process) of a transmission delay difference by the signal line SL between the two lanes, and performs the setting process (correction process) for correcting a transmission delay difference between the two lanes. Note that, hereinafter, two neighboring lanes which are sequentially shifted and selected are referred to as a “lane pair”, one lane is referred to as a “primary lane”, and the other lane is referred to as a “secondary lane”.

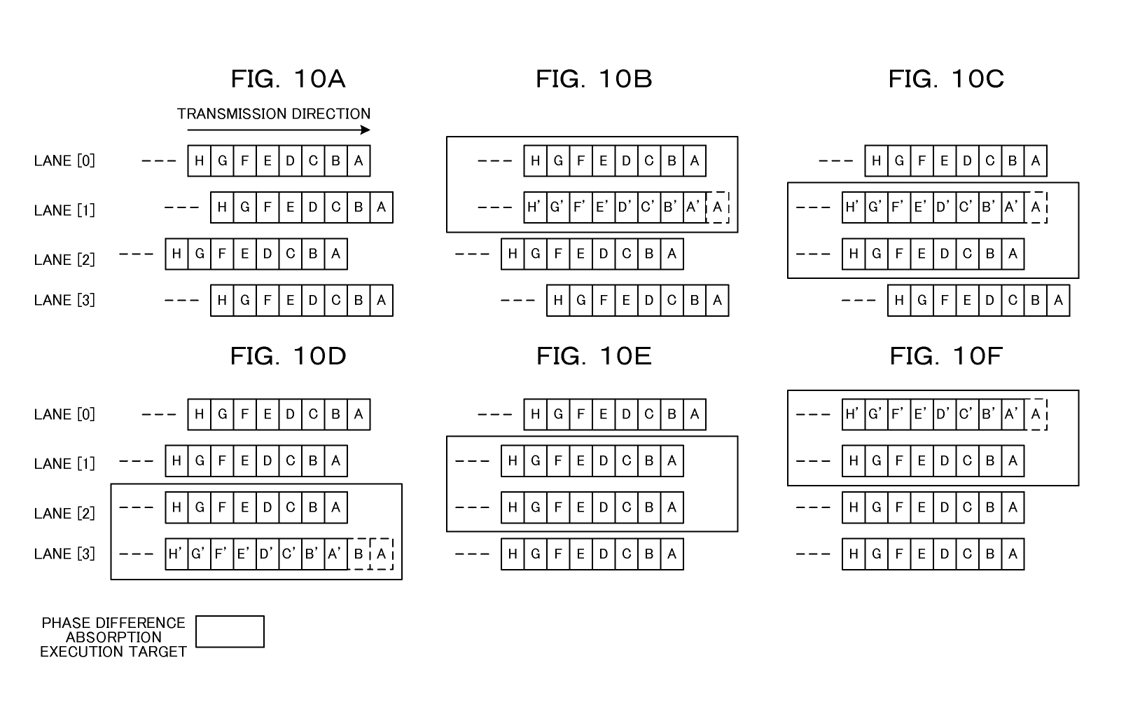

More specifically, the absorption processing unit performs the setting process (correction process) in collaboration with the absorption processing unit (the pattern detecting circuit 25 and the inter-lane transmission delay difference absorption control circuit 26) equipped in the receiving unit 20-(i−1) or 20-(i+1) in the neighboring lane. At this time, the absorption processing unit sequentially shift-selects two lanes until reaching from the lane [0] of one end to the lane [n] of the other end in the plurality of lanes [0] to [n], and performs the setting process each time two lanes are selected. Thereafter, the absorption processing unit sequentially shift-selects two lanes until reaching from the lane [n] of the other end to the lane [0] of one end in the plurality of lanes [0] to [n] which have been subjected to the setting process, and performs the setting process again each time two lanes are selected. A lane pair selection operation performed by a lane control unit 26b (which will be described later) of the inter-lane transmission delay difference absorption control circuit 26 included in the absorption processing unit will be described later with reference to FIGS. 10 to 37.

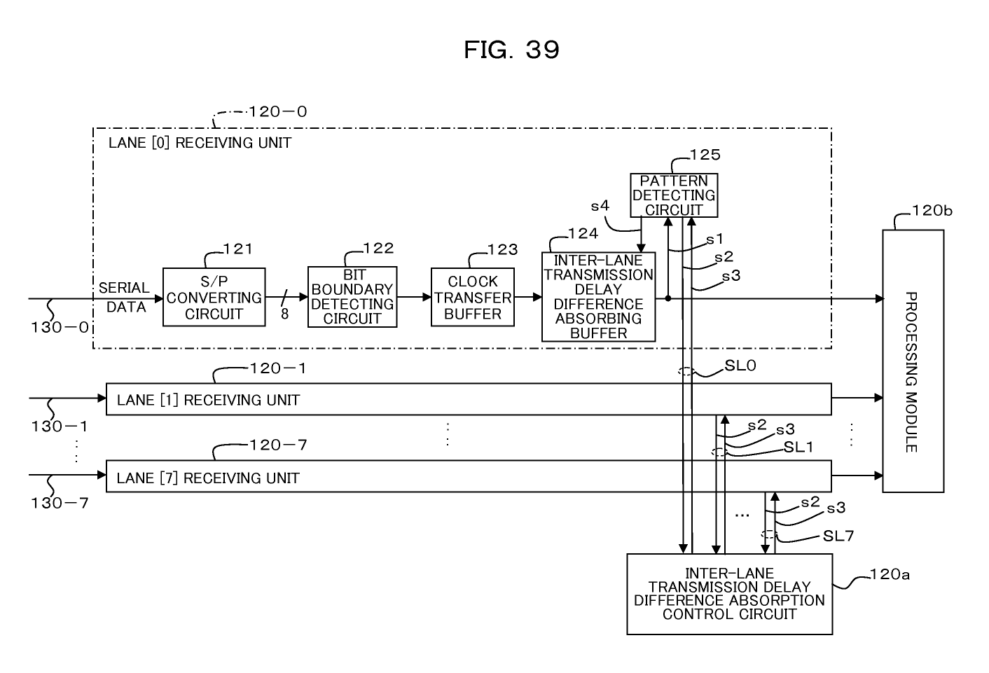

In the setting process described above with reference to FIG. 39, the pattern detection signal of each lane of the transmission delay difference absorption target is first collected in the single control circuit 120a, and then the stop signal is transmitted from the single control circuit 120a to the receiving units of all lanes.

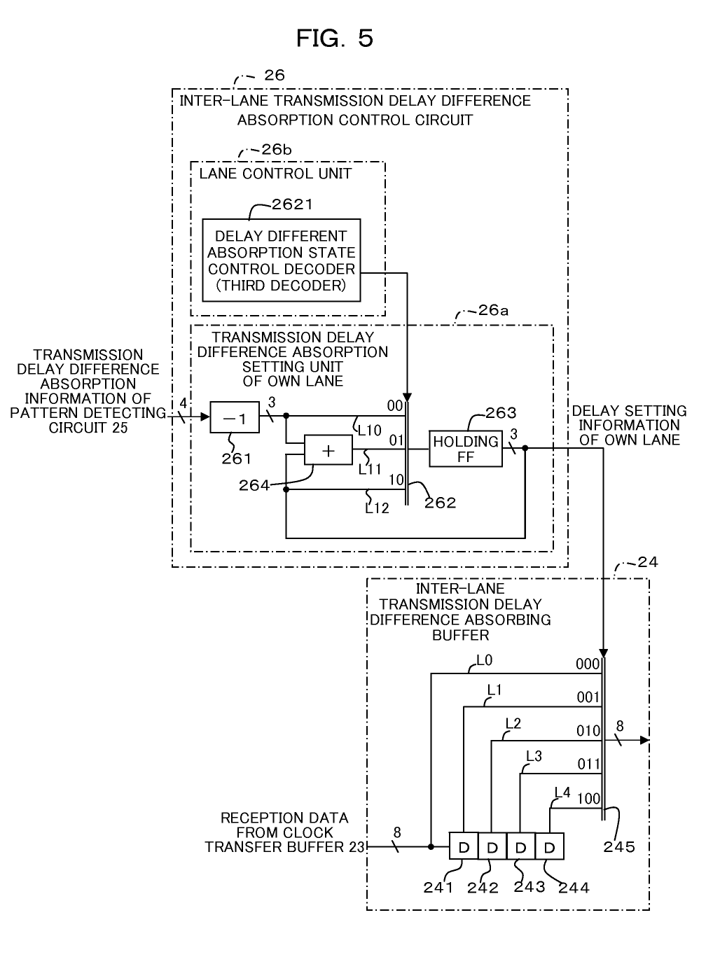

On the other hand, in the present embodiment, the receiving units 20-0 to 20-n of the plurality of lanes [0] to [n] are connected to one another through the signal line SL in a beaded form as illustrated in FIG. 1. Through this configuration, the pattern detecting circuits 25 and the inter-lane transmission delay difference absorption control circuits 26 in the neighboring lanes perform the setting process (correction process) for correcting a transmission delay difference between neighboring lanes while exchanging information (which will be described later) related to the transmission delay difference absorption setting process. Here, the setting process (correction process) is a process of setting the data read-out position of the inter-lane transmission delay difference absorbing buffer 24 during the initialization period of time of the device 1 through the pattern detecting circuit 25 and the inter-lane transmission delay difference absorption control circuit 26. For example, the data read-out position refers to a read-out buffer stage number designated by the read pointer as will be described later with reference to FIG. 5.

In other words, in the present embodiment, information (which will be described later) related to the transmission delay difference absorption setting process is collected by the pattern detecting circuit 25 and the inter-lane transmission delay difference absorption control circuit 26 in the lane connected in the beaded form while shifting and selecting a lane pair sequentially. Then, based on the collected information, the absorption processing unit of a lane which is smaller in a transmission delay difference in the lane pair adjusts a data read-out timing of its own inter-lane transmission delay difference absorbing buffer 24 to that of the inter-lane transmission delay difference absorbing buffer 24 of a lane that is larger in a transmission delay difference. Through this operation, the setting process (correction process) of correcting a transmission delay difference between a pair of lanes is sequentially performed on all the lanes [0] to [n] without using the shared single control circuit 120a as illustrated in FIG. 39.

[1-3] Configuration of Receiving Module

Next, a configuration of the receiving module (communication device) 20 including the transmission delay difference absorbing device according to the present embodiment will be described with reference to FIGS. 2 and 3. Here, FIG. 2 is a block diagram illustrating configurations of the receiving module 20 and each lane [i] receiving unit 20-i, and FIG. 3 is a block diagram illustrating main components of the receiving module 20 and an interconnection state of the signal lines SL among the lanes [0] to [n]. Note that, FIGS. 2 and 3 illustrate detailed configurations of the receiving units 20-0 and 20-2 for the lanes [0] and [2], and the receiving units 20-3 to 20-n for the lanes [3] to [n] include the same configuration.

As illustrated in FIGS. 2 and 3, each receiving unit 20-i in the receiving module 20 includes an S/P converting circuit 21, a bit boundary detecting circuit 22, a clock transfer buffer 23, an inter-lane transmission delay difference absorbing buffer (hereinafter, referred to as a “buffer”) 24, the pattern detecting circuit 25, and an inter-lane transmission delay difference absorption control circuit (hereinafter, referred to as a “control circuit”) 26. Note that, the S/P converting circuit 21, the bit boundary detecting circuit 22, and the clock transfer buffer 23 include the same functions as the S/P converting circuit 121, the bit boundary detecting circuit 122, and the clock transfer buffer 123 which have been described above with reference to FIG. 39, respectively, and thus a detailed description thereof will not be repeated.

The buffer 24 is the same as the buffer 124 illustrated in FIG. 39, and temporarily holds the partial data from the clock transfer buffer 23 and absorbs a transmission delay difference between each pair of the lanes [0] to [n]. The holding period of time (the data read-out position) of the partial data in the buffer 24 is set as the initialization period of time through the pattern detecting circuit 25 and the control circuit 26. Note that, the buffer 24 has a buffer stage number capable of absorbing the maximum transmission delay difference predicted based on design information of a transmission path. A concrete configuration of the buffer 24 will be described later with reference to FIG. 5.

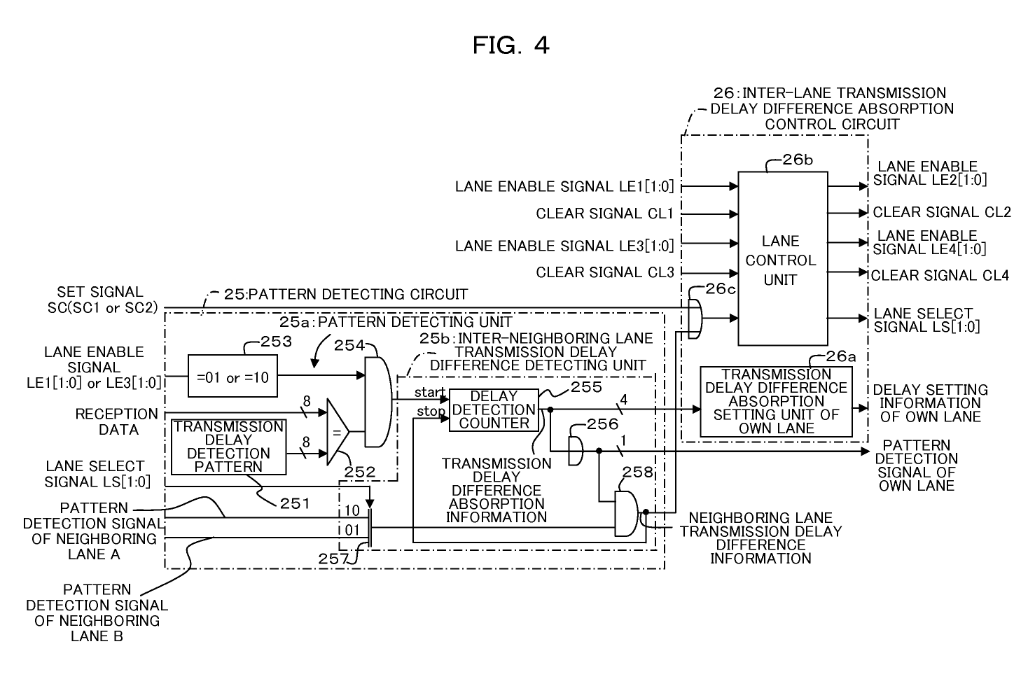

The pattern detecting circuit (detecting unit) 25 has functions of a pattern detecting unit 25a and a transmission delay difference detecting unit 25b which will be described later with reference to FIG. 4.

The control circuit 26 has functions of a transmission delay difference absorption setting unit 26a, the lane control unit 26b and an OR gate 26c which will be described later with reference to FIGS. 4 to 6.

In the present embodiment, instead of the single control circuit 120a illustrated in FIG. 39, each lane [i] includes the control circuit 26 capable of performing an initial setting of a buffer stage number for correcting a transmission delay difference between neighboring lanes as illustrated in FIGS. 2 and 3. The control circuit 26 of each lane [i] is connected to not only the pattern detecting circuit 25 in the same lane [i] but also the control circuits 26 of the neighboring lanes [i−1] and [i+1] through the signal lines SL. The pattern detecting circuit 25 of each lane [i] is connected to the pattern detecting circuits 25 of the neighboring lanes [i−1] and [i+1] through the signal lines SL in order to collect information (the pattern detection signal) related to the transmission delay difference absorption setting process from the neighboring lanes [i−1] and [i+1].

[1-4] Signal and Signal Connection Relation Between Lanes

Here, signals input to the pattern detecting circuit 25 and the control circuit 26 through the signal lines SL and signals output from the pattern detecting circuit 25 and the control circuit 26 through the signal lines SL in each lane [i] will be described with reference to FIG. 3. Further, a signal connection relation between each lane [i] and the neighboring lanes [i−1] and [i+1] will be described.

The pattern detection signal of the neighboring lane [i−1] and the pattern detection signal of the neighboring lane [i+1] are input to the pattern detecting circuit 25 of each lane [i] as the information related to the transmission delay difference absorption setting process. The pattern detecting circuit 25 of each lane [i] outputs the pattern detection signal of its own lane [i] to the pattern detecting circuits 25 of the neighboring lanes [i−1] and [i+1] as the information related to the transmission delay difference absorption setting process. Note that, in the drawings or the following description, the neighboring lane [i−1] is referred to as a “neighboring lane A”, and the neighboring lane [i+1] is referred to as a “neighboring lane B”.

Note that, the lane [0] of one end is arranged at the edge and not connected to a lane corresponding to the neighboring lane [i−1]. For this reason, “0” is constantly input to the pattern detecting circuit 25 of the lane [0] as the pattern detection signal of a lane corresponding to the neighboring lane [i−1]. Further, a line through which the pattern detection signal of its own lane [0] is output to a lane corresponding to the neighboring lane [i−1] is opened. Similarly, the lane [n] of the other end is arranged at the edge and not connected to a lane corresponding to the neighboring lane [i+1]. For this reason, “0” is constantly input to the pattern detecting circuit 25 of the lane [n] as the pattern detection signal of a lane corresponding to the neighboring lane [i+1]. Further, a line through which the pattern detection signal of its own lane [n] is output to a lane corresponding to the neighboring lane [i+1] is opened.

A 2-bit signal LE (lane enable) 2[1:0] of the neighboring lane [i−1] and a 1-bit signal CL (clear) 4 of the neighboring lane [i−1] are input to the control circuit 26 of each lane [i] as a 2-bit signal LE1[1:0] and a 1-bit signal CL3, respectively.

The control circuit 26 of each lane [i] outputs a 2-bit signal LE4[1:0] as a 2-bit signal LE3[1:0] of the neighboring lane [i−1] and outputs a 1-bit signal CL2 as a 1-bit signal CL1 of the neighboring lane [i−1].

Similarly, the 2-bit signal LE4[1:0] of the neighboring lane [i+1] and the 1-bit signal CL2 of the neighboring lane [i+1] are input to the control circuit 26 of each lane [i] as the 2-bit signal LE3[1:0] and the 1-bit signal CL1, respectively. Further, the control circuit 26 of each lane [i] outputs the 2-bit signal LE2[1:0] as the 2-bit signal LE1[1:0] of the neighboring lane [i+1] and outputs the 1-bit signal CL4 as the 1-bit signal CL3 of the neighboring lane [i+1].

Note that, the lane [0] of one end is arranged at the edge and not connected to the lane corresponding to the neighboring lane [i−1]. For this reason, the initialization state machine 20b is connected to the control circuit 26 of the lane [0] as the control circuit 26 of the lane corresponding to the neighboring lane [i−1], and the signals LE1 to LE4 and the signals CL1 to CL4 are exchanged between the control circuit 26 of the lane [0] and the initialization state machine 20b. Similarly, the lane [n] of the other end is arranged at the edge and not connected to the lane corresponding to the neighboring lane [i+1]. For this reason, the termination logic 20c is connected to the control circuit 26 of the lane [n] as the control circuit 26 of the lane corresponding to the neighboring lane [i+1], and the signals LE1 to LE4 and the signals CL1 to CL4 are exchanged between the control circuit 26 of the lane [n] and the termination logic 20c.

As will be described later with reference to FIGS. 4, 6, 20, and 21, when lane pair selection is turned back, a set signal SC1 for setting a flag “complete 1” of the lane control unit 26b (which will be described later) is input from the termination logic 20c to the control circuit 26 of the lane [n] as neighboring lane transmission delay information. Similarly, as will be described later with reference to FIGS. 4, 6, 34, and 35, when the setting process is completed, a set signal SC2 for setting a flag “complete 2” of the lane control unit 26b (which will be described later) is input from the initialization state machine 20b to the control circuit 26 of the lane [0] as the neighboring lane transmission delay information.

Further, a signal (information) exchanged between the pattern detecting circuit 25 and the control circuit 26 of each lane [i] is as follows. A count value obtained by a delay detection counter 255 (which will be described later) is transmitted from the pattern detecting circuit 25 to the control circuit 26 as transmission delay difference absorption information, and a logical product result obtained by an AND gate 258 (which will be described later) is transmitted from the pattern detecting circuit 25 to the control circuit 26 as neighboring lane transmission delay difference information. A logical sum result obtained by an OR gate 2623 (which will be described later) is transmitted from the control circuit 26 to the pattern detecting circuit 25 as a 2-bit signal LS (lane select) [1:0].

Further, the signals LE1 and LE3 from the neighboring lanes [i−1] and [i+1] are input to the pattern detecting circuit 25 of each lane [i] as will be described later with reference to FIG. 4. Further, delay setting information of its own lane [i] by the transmission delay difference absorption setting unit 26a of the control circuit 26 is input to the buffer 24 of each lane [i] as will be described later with reference to FIGS. 4 and 5.

As described above, various signals are exchanged between neighboring lanes through the signal line SL, and a delay setting of the buffer 24 is made for each lane pair while sequentially shifting and selecting a lane pair from the lane [0] to the lane [n]. Further, when the shift direction of the lane pair selection is turned back by the termination logic 20c, a delay setting of the buffer 24 is made for each lane pair while sequentially shifting and selecting a lane pair from the lane [n] to the lane [0]. The setting process (correction process) for correcting the transmission delay difference between each pair of all the lanes [0] to [n] is performed such that a delay setting of the buffer 24 is made while shifting the lane pair selection in the reciprocating manner. Note that, hereinafter, a period of time in which a lane pair is shifted from the lane [0] to the lane [n] may be referred to as an “outward path”, and a period of time in which a lane pair is shifted from the lane [n] to the lane [0] may be referred to as a “return path”.

[1-5] Configuration of Absorption Processing Unit

Hereinafter, a detailed configuration and function of the absorption processing unit that performs the setting process (correction process) for correcting the transmission delay difference between each pair of all the lanes [0] to [n], that is, configurations and functions of the buffer 24, the pattern detecting circuit 25 and the control circuit 26 in each lane [i] will be described with reference to FIGS. 4 to 8.

[1-5-1] Configuration of Pattern Detecting Circuit 25

FIG. 4 is a block diagram illustrating a configuration of the pattern detecting circuit 25 and a configuration of the inter-lane transmission delay difference absorption control circuit 26.

The pattern detecting circuit 25 includes the pattern detecting unit 25a and the inter-neighboring lane transmission delay difference detecting unit 25b as illustrated in FIG. 4.

The pattern detecting unit 25a has a function of comparing partial data (for example, 8-bit data) read from the clock transfer buffer 23 with a specific pattern which is previously decided between the transmission side and the reception side and determining whether the partial data is the specific pattern. In order to implement this function, the pattern detecting unit 25a includes a transmission delay detection pattern storage unit 251, a comparator 252, a determining circuit 253, and an AND gate 254.

The transmission delay detection pattern storage unit 251 stores a specific pattern which is previously decided between the transmission side and the reception side. For example, the specific pattern is 8-bit parallel data.

The comparator 252 compares the 8-bit data read from the clock transfer buffer 23 with the specific pattern of the transmission delay detection pattern storage unit 251, and outputs “1” when the 8-bit data matches the specific pattern and outputs “0” otherwise.

The determining circuit 253 is configured by a logical circuit to output “1” when a lane enable signal LE1[1:0] or LE3[1:0] from the neighboring lane [i−1] or [i+1] is “01” or “10” and outputs “0” otherwise. Note that, the lane enable signal LE1[1:0] or LE3[1:0] becomes “01” or “10” when its own lane [i] is selected as a lane pair.

The AND gate 254 outputs a logical product of an output of the comparator 252 and an output of the determining circuit 253. In other words, the AND gate 254 outputs “1” when the signal LE1[1:0] or LE3[1:0] is “01” or “10” and the 8-bit data read from the clock transfer buffer 23 is the specific pattern and outputs “0” otherwise. More specifically, the AND gate 254 outputs “1” when its own lane [i] is selected as a lane pair and the specific pattern is detected.

The inter-neighboring lane transmission delay difference detecting unit (transmission delay difference detecting unit) 25b has a function of detecting a transmission delay difference between its own lane [i] and the neighboring lane [i−1] or [i+1] based on a detection timing of the specific pattern of its own lane [i] and a detection timing of the specific pattern of the neighboring lane [i−1] or [i+1]. In order to implement this function, the inter-neighboring lane transmission delay difference detecting unit includes the delay detection counter 255, an OR gate 256, a selector 257, and the AND gate 258.

The delay detection counter 255 starts an increment (counting) when an output of the AND gate 254 is “1”, that is, at a timing at which its own lane [i] is selected as a lane pair and the specific pattern is detected. The delay detection counter 255 stops the counting operation at a rising edge of an output of the AND gate 258 which will be described later. Note that, the initial value of the count value of the delay detection counter 255 is set to “0”. In addition, the delay detection counter 255 illustrated in FIG. 4 outputs 4-bit data as the count value.

The OR gate 256 outputs a logical sum of 4-bit data which is an output (count value) of the delay detection counter 255 as the pattern detection signal of its own lane [i]. More specifically, the OR gate 256 outputs “0” in a state in which the delay detection counter 255 does not start counting, that is, in a state in which the delay detection counter 255 outputs an initial value “0000”. The OR gate 256 outputs “1” in a state in which the delay detection counter 255 starts counting, that is, in a state in which at least one bit of 4-bit data is “1”. Through this operation, the OR gate 256 notifies the neighboring lanes [i−1] and [i+1] of the pattern detection signal representing that the specific pattern has been detected in its own lane [i] at a timing at which the delay detection counter 255 starts counting and the count value is 1.

The selector 257 selects and outputs the pattern detection signal of the neighboring lane [i+1] (the neighboring lane B in FIG. 4) when the lane select signal LS[1:0] output from the control circuit 26 (the lane control unit 26b which will be described later) is “01”. The lane select signal LS[1:0] becomes “01” when its own lane [i] is a primary lane of a lane pair on the outward path or when its own lane [i] is a secondary lane of a lane pair on the return path as will be described later. Meanwhile, the selector 257 selects and outputs the pattern detection signal of the neighboring lane [i−1] (the neighboring lane A in FIG. 4) when the lane select signal LS[1:0] output from the control circuit 26 (the lane control unit 26b which will be described later) is “10”. The lane select signal LS[1:0] becomes “10” when its own lane [i] is a secondary lane of a lane pair on the outward path or when its own lane [i] is a primary lane of a lane pair on the return path as will be described later.

The AND gate 258 outputs a logical product of an output of the OR gate 256 and an output of the selector 257 as the neighboring lane transmission delay difference information. In other words, the AND gate 258 outputs “1” when the pattern detection signal of its own lane [i] is “1” and the pattern detection signal of the neighboring lane [i−1] or [i+1] forming a lane pair together with its own lane [i] is “1” and outputs “0” otherwise.

The neighboring lane transmission delay difference information which is an output of the AND gate 258 is input to the delay detection counter 255 as the counting stop signal and input to the control circuit 26 (the OR gate 26c which will be described later).

Further, when an output of the AND gate 258 is “1”, the delay detection counter 255 stops the counting operation, and outputs a count value at a point in time when the counting operation is stopped, that is, the transmission delay difference of its own lane [i] to the control circuit 26 (the transmission delay difference absorption setting unit 26a which will be described later) as the transmission delay difference absorption information (4-bit data) of the own lane [i]. However, in the present embodiment, as described above, the pattern detection signal of each lane is output when the delay detection counter 255 performs an increment once and an output of the delay detection counter 255 changes from “0” to “1”. For this reason, transmission delay difference obtained by the delay detection counter 255 of each lane is increased by 1. Thus, a process of subtracting 1 from the same count value through a subtracter 261 (which will be described later) is performed before the count value of the delay detection counter 255 is used by the transmission delay difference absorption setting unit 26a of the subsequent stage.

The count value counted by the delay detection counter 255 is “1” when a transmission delay difference between its own lane [i] and the neighboring lane [i−1] or [i+1] is 0 (zero). Further, when data transmission of its own lane [i] is slower than that of the neighboring lane [i−1] or [i+1], the counting stop signal is received directly after the counter 255 starts counting, and thus the count value counted by the delay detection counter 255 becomes “1”. Meanwhile, when data transmission of its own lane [i] is faster than that of the neighboring lane [i−1] or [i+1], the counter 255 starts the counting and then performs the counting until the pattern detection signal is received from the neighboring lane [i−1] or [i+1]. Through this operation, the count value counted by the delay detection counter 255 becomes a value obtained by adding 1 (one) to the count value according to the transmission delay difference between its own lane [i] and the neighboring lane [i−1] or [i+1].

[1-5-2] Configuration of Inter-Lane Transmission Delay Difference Absorption Control Circuit 26

The inter-lane transmission delay difference absorption control circuit 26 includes the transmission delay difference absorption setting unit 26a, the lane control unit 26b, and the OR gate 26c as illustrated in FIG. 4.

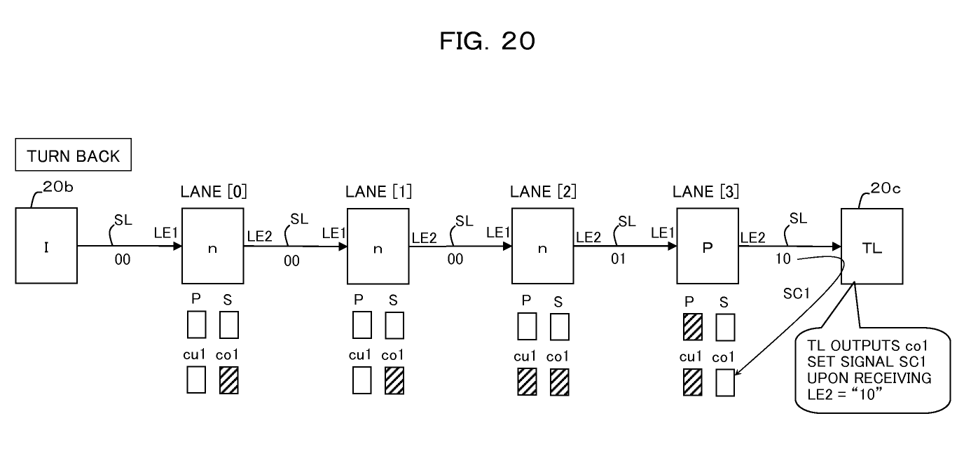

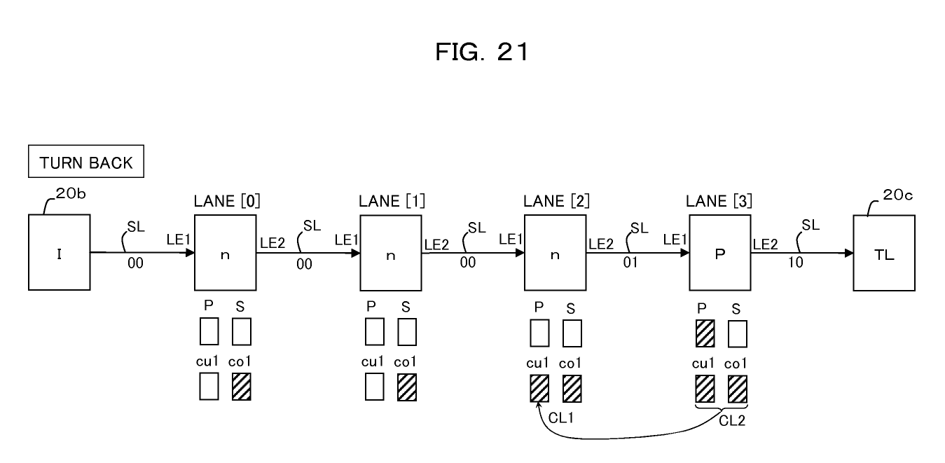

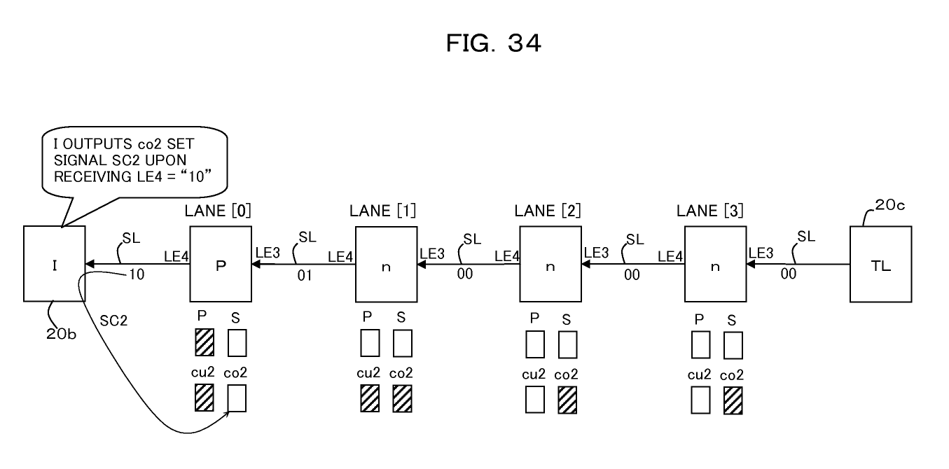

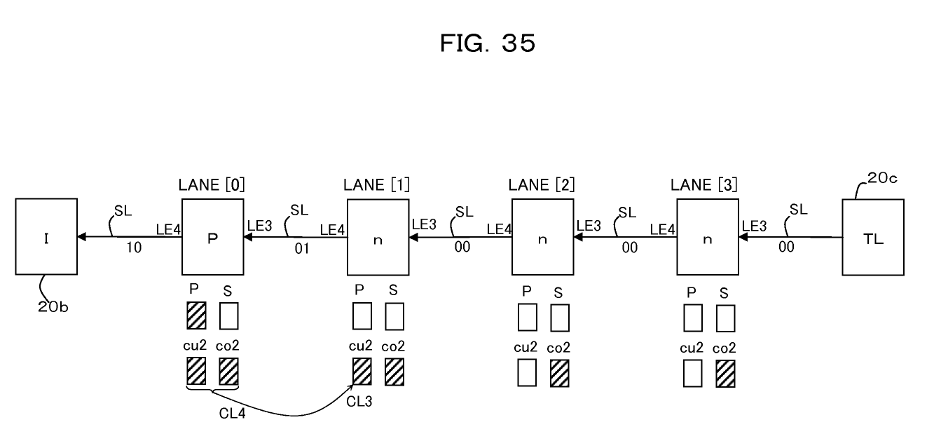

The OR gate 26c outputs a logical sum of the neighboring lane transmission delay information from the AND gate 258 of the transmission delay difference detecting unit 25b and a signal SC which will be described later. Here, the signal SC input to the OR gates 26c of the lanes [1] to [n−1] is fixed to “0”. As the signal SC input to the OR gate 26c of the lane [0] of one end, the set signal SC2 for setting the flag “complete 2” of the lane control unit 26b when the setting process is completed is input from the initialization state machine 20b (see FIGS. 34 and 35). Further, as the signal SC input to the OR gate 26c of the lane [n] of the other end, the set signal SC1 for setting the flag “complete 1” of the lane control unit 26b when the lane pair selection is turned back is input from the termination logic 20c (see FIGS. 20 and 21). Further, an output of the OR gate 26c is input to determining circuits 2602 and 2604 of the lane control unit 26b as the neighboring lane transmission delay difference information as will be described later.

The transmission delay difference absorption setting unit (buffer control unit) 26a has a function of temporarily storing a transmission delay difference detected by the transmission delay difference detecting unit 25b until selection of a lane pair reaches from the lane [0] to the lane [n] as the transmission delay difference absorption information. The transmission delay difference absorption setting unit 26a further has a function of adding the stored transmission delay difference to the transmission delay difference detected by the transmission delay difference detecting unit 25b until selection of a lane pair reaches from the lane [n] to the lane [0]. The transmission delay difference absorption setting unit 26a further has a function of setting a read-out position of partial data from the buffer 24 so that the value (transmission delay difference) obtained by the addition is absorbed by the buffer 24. A detailed configuration of the transmission delay difference absorption setting unit 26a having the above-described functions will be described later with reference to FIG. 5.

The lane control unit 26b performs the following function in collaboration with the lane control unit 26b of the neighboring lane by exchanging a signal with the lane control unit 26b of the neighboring lane through the signal line SL. In other words, the lane control unit 26b sequentially selects a lane pair on the outward path until reaching from the lane [0] to the lane [n]. Then, the lane control unit 26b causes the pattern detecting unit 25a, the transmission delay difference detecting unit 25b, and the buffer control unit 26a to perform the setting process of correcting a transmission delay difference of a selected lane pair each time when a lane pair is selected. Thereafter, the lane control unit 26b sequentially selects a lane pair on the return path until reaching from the lane [n] to the lane [0] in the lanes [0] to [n] which have been subjected to the setting process. Then, the lane control unit 26b causes the pattern detecting unit 25a, the transmission delay difference detecting unit 25b, and the buffer control unit 26a to perform again the setting process of correcting a transmission delay difference of a selected lane pair each time when a lane pair is selected.

Note that, the lane control unit 26b of the lane [i] receives the lane enable signal LE1[1:0] and the clear signal CL1 from the neighboring lane, and outputs the lane enable signal LE2[1:0] and the clear signal CL2 to the neighboring lane. At this time, the lane enable signal LE1[1:0] is the lane enable signal LE2[1:0] of the neighboring lane [i−1], and the clear signal CL1 is the clear signal CL2 of the neighboring lane [i+1]. Further, the lane enable signal LE2[1:0] is output as the lane enable signal LE1[1:0] of the neighboring lane [i+1], and the clear signal CL2 is output as the clear signal CL1 of the neighboring lane [i−1].

The signals LE1[1:0], LE2[1:0], CL1, and CL2 are used in the outward path in which a lane pair shifts from the lane [0] to the lane [n] and fixed to “0” in the return path in which a lane pair shifts from the lane [n] to the lane [0].

Similarly, the lane control unit 26b of the lane [i] receives the lane enable signal LE3[1:0] and the clear signal CL3 from the neighboring lane, and outputs the lane enable signal LE4[1:0] and the clear signal CL4 to the neighboring lane. At this time, the lane enable signal LE3[1:0] is the lane enable signal LE4[1:0] of the neighboring lane [i+1], and the clear signal CL3 is the clear signal CL4 of the neighboring lane [i−1]. Further, the lane enable signal LE4[1:0] is output as the lane enable signal LE3[1:0] of the neighboring lane [i−1], and the clear signal CL4 is output as the clear signal CL3 of the neighboring lane [i+1]. The signals LE3[1:0], LE4[1:0], CL3, and CL4 are used in the return path in which a lane pair shifts from the lane [n] to the lane [0] and fixed to “0” in the outward path in which a lane pair shifts from the lane [0] to the lane [n].

Further, the lane control unit 26b outputs the lane select signal LS[1:0] to the selector 257 of the pattern detecting circuit 25, and outputs the delay setting information of its own lane [i] to the transmission delay difference absorption setting unit 26a.

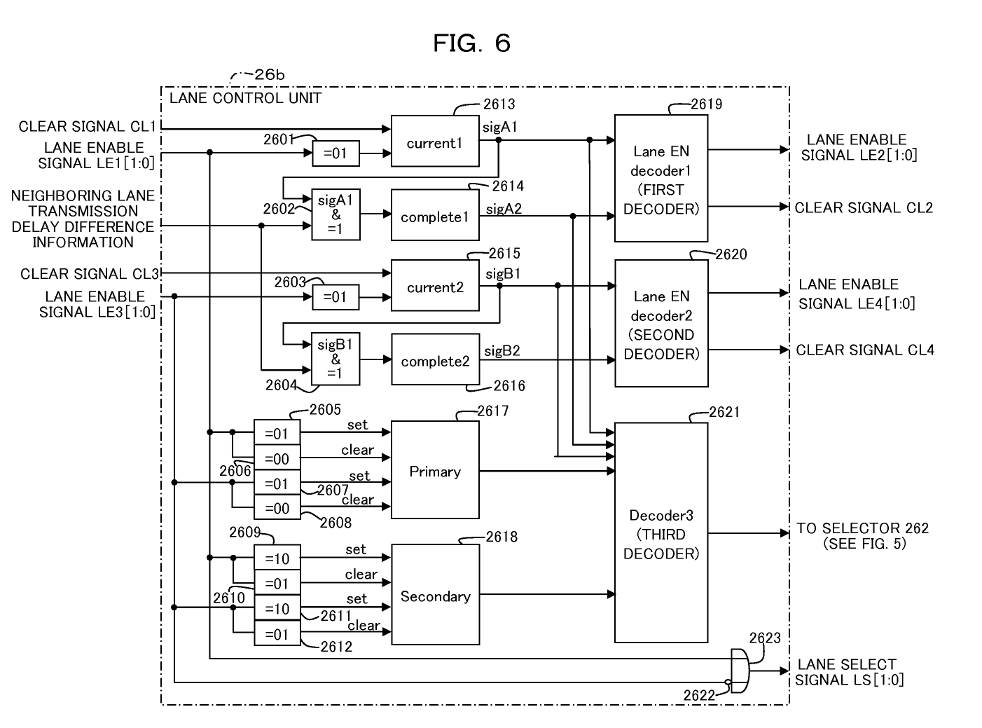

A detailed configuration of the lane control unit 26b having the above-described functions will be described later with reference to FIGS. 6 to 8.

Further, selection of a lane pair is reciprocated once while shifting the lane pair between the lane [0] and the lane [n] using the inter-lane transmission delay difference absorption control circuit 26 having the above-described functions. Further, each time a lane pair is selected, the setting process of correcting a transmission delay difference of a selected lane pair is performed. For example, the lanes [0] and [1] are selected, then the setting process is performed, and thereafter, the lanes [1] and [2] are selected, and then the setting process is performed. This process is repeatedly performed, and so the lanes [n−1] and [n] are selected and the setting process is performed, and thereafter the turn-back operation of the lane pair selection is performed by the termination logic 20c. Thereafter, the lanes [n] and [n−1] are selected, then the setting process is performed, and thereafter the lanes [n−1] and [n−2] are selected, then the setting process is performed. This process is repeatedly performed, and so the lanes [1] and [0] are selected and the setting process is performed, and thereafter the end process of the lane pair selection is performed by the initialization state machine 20b. Through this process, the setting process of correcting a transmission delay difference is performed on all the lanes [0] to [n].

[1-5-3] Configuration of Inter-Lane Transmission Delay Difference Absorbing Buffer 24

FIG. 5 is a block diagram illustrating a configuration of the inter-lane transmission delay difference absorbing buffer 24 and a configuration of the transmission delay difference absorption setting unit 26a in the control circuit 26.

The inter-lane transmission delay difference absorbing buffer 24 includes buffers (D) 241 to 244 of four stages and a selector 245 as illustrated in FIG. 5. The buffer 24 has a stage number capable of absorbing a transmission delay difference of a transmission path. The stage number is decided in advance as one of design factors of a transmission path.

The buffers 241 to 244 of four stages are connected in series to an output line of the clock transfer buffer 23, and receive 8-bit data from the clock transfer buffer 23.

A line L0, which bypasses the buffers 241 to 244 of four stages from the output line of the clock transfer buffer 23, is connected to the selector 245, and output lines L1 to L4 of the buffers 241 to 244 of four stages are connected to the selector 245.

The selector 245 selectively switches and outputs data of one of the five lines L0 to L4 according to a value held in a holding flip-flop (FF) 263 (which will be described later) of the transmission delay difference absorption setting unit 26a. For example, the value held in the holding FF 263 is 3-bit data representing a transmission delay difference between its own lane [i] and the neighboring lane and is used as the read pointer of the buffer 24. When the value of the holding FF 263 is “000”, the selector 245 selects the line L0 and outputs the 8-bit data from the clock transfer buffer 23 as is without any delay. When the value of the holding FF 263 is “001”, the selector 245 selects the line L1, that is, the buffer 241 of the first stage as the data read-out position, delays the 8-bit data from the clock transfer buffer 23 by one clock by the buffer 241, and then outputs the delayed 8-bit data. When the value of the holding FF 263 is “010”, the selector 245 selects the line L2, that is, the buffer 242 of the second stage as the data read-out position, delays the 8-bit data from the clock transfer buffer 23 by two clocks by the buffers 241 and 242, and then outputs the delayed 8-bit data. When the value of the holding FF 263 is “011”, the selector 245 selects the line L3, that is, the buffer 243 of the third stage as the data read-out position, delays the 8-bit data from the clock transfer buffer 23 by three clocks by the buffers 241 to 243, and then outputs the delayed 8-bit data. When the value of the holding FF 263 is “100”, the selector 245 selects the line L4, that is, the buffer 244 of the fourth stage as the data read-out position, delays the 8-bit data from the clock transfer buffer 23 by four clocks by the buffers 241 to 244, and then outputs the delayed 8-bit data.

[1-5-4] Configuration of Transmission Delay Difference Absorption Setting Unit 26a

The transmission delay difference absorption setting unit 26a includes the subtracter 261, a selector 262, the holding FF 263, and an adder 264 as illustrated in FIG. 5.

The subtracter 261 subtracts 1 from the transmission delay difference absorption information of the pattern detecting circuit 25, that is, the count value obtained by the delay detection counter 255. The reason for performing the process of subtracting 1 from the count value through the subtracter 261 is because a transmission delay difference is “1” even when a transmission delay difference obtained by the delay detection counter 255 is counted by 1 and there is no transmission delay difference between two lanes as described above with reference to FIG. 4. Thus, when the above-described latency does not occur in the delay detection counter 255, the present device can be implemented even when the subtracter 261 is not disposed. Note that, in the present embodiment, the count value by the delay detection counter 255 is 4-bit data, and data output from the subtracter 261 is 3-bit data since 1 is subtracted.

A line L10 from the subtracter 261, a line L11 from the adder 264 (which will be described later), and a line L12 from the holding FF 263 (which will be described later) are connected to the selector 262.

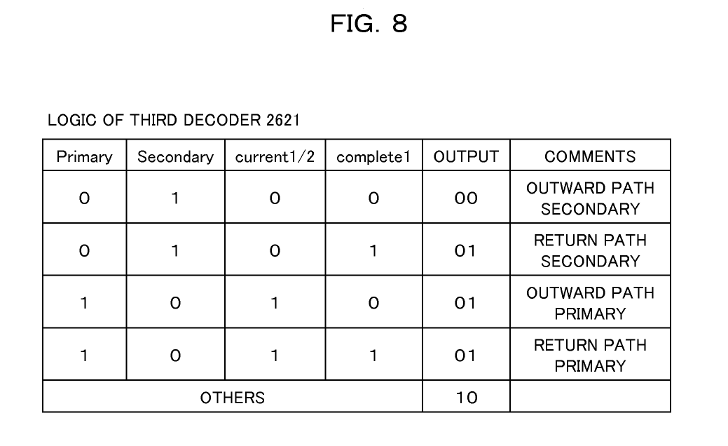

The selector 262 selectively switches data from one of the three lines L10 to L12 according to an output value (a switching signal) of a delay difference absorption state control decoder (a third decoder which will be described later) 2621 of the lane control unit 26b, and then outputs the data to the holding FF 263. For example, the output value of the decoder 2621 is 2-bit data as will be described later with reference to FIGS. 6 and 8. When the output value of the decoder 2621 is “00”, the selector 262 selects the line L10, and outputs a value from the subtracter 261 to be held in the holding FF 263. When the output value of the decoder 2621 is “01”, the selector 262 selects the line L11, and outputs a value from the adder 264 to be held in the holding FF 263. When the output value of the decoder 2621 is “10” or “11”, the selector 262 selects the line L12, and outputs a value of the holding FF 263 to be held in the holding FF 263 again. In other words, when the output value of the decoder 2621 is “10” or “11”, the holding FF 263 continuously holds the same value.

The holding FF 263 holds the value output from the selector 262 as the transmission delay difference (the transmission delay difference absorption information) of its own lane [i], and outputs the value to the selector 245 of the buffer 24 as the delay setting information of its own lane [i]. The value held in the holding FF 263 is used as the read pointer of the buffer 24 as described above.

The adder 264 outputs a value, obtained by adding the value from the subtracter 261 and the value from the holding FF 263, to the selector 262 through the line L11.

Next, an operation of the transmission delay difference absorption setting unit 26a according to the output value of the delay difference absorption state control decoder 2621 of the lane control unit 26b will be described.

The transmission delay difference absorption process (correction process) in each lane [i] is performed a total of four times at the following timing without any leakage. In other words, the process is performed a total of four times: when the lane [i] is selected as a secondary lane in the outward path; when the lane [i] is selected as a primary lane in the outward path; when the lane [i] is selected as a secondary lane in the return path; and when the lane [i] is selected as a primary lane in the return path. Hereinafter, the correction process includes the transmission delay difference absorbing process performed such that the transmission delay difference is removed.

In the first process (at the time of outward path secondary), the output value of the delay difference absorption state control decoder 2621 is “00” (see FIG. 8), the transmission delay value from the line L10, that is, the subtracter 261 is selected by the selector 245 and stored in the holding FF 263 as the transmission delay difference absorption information of the first process.

In the second process (at the time of outward path primary), the output value of the delay difference absorption state control decoder 2621 is “01” (see FIG. 8), the transmission delay value from the line L11, that is, the adder 264 is selected by the selector 245 and stored in the holding FF 263 as the transmission delay difference absorption information of the second process. In other words, the transmission delay value newly obtained by the subtracter 261 is added to the transmission delay value of the first process held in the holding FF 263 by the adder 264, and the addition value is stored in the holding FF 263 as the transmission delay difference absorption information of the second process.

In the third process (at the time of return path secondary), the output value of the delay difference absorption state control decoder 2621 is “01” (see FIG. 8), and the transmission delay value from the line L11, that is, the adder 264 is selected by the selector 245 and stored in the holding FF 263 as the transmission delay difference absorption information of the third process. In other words, the transmission delay value newly obtained by the subtracter 261 is added to the transmission delay value of the second process held in the holding FF 263 by the adder 264, and the addition value is stored in the holding FF 263 as the transmission delay difference absorption information of the third process.

In the fourth process (at the time of return path primary), the output value of the delay difference absorption state control decoder 2621 is “01” (see FIG. 8), the transmission delay value from the line L11, that is, the adder 264 is selected by the selector 245 and stored in the holding FF 263 as the transmission delay difference absorption information of the fourth process. In other words, the transmission delay value newly obtained by the subtracter 261 is added to the transmission delay value of the third process held in the holding FF 263 by the adder 264, and the addition value is stored in the holding FF 263 as the transmission delay difference absorption information of the fourth process.

At a timing other than four timings described above, the output value of the delay difference absorption state control decoder 2621 is “01” (see FIG. 8), and the transmission delay value from the line L12, that is, the holding FF 263 is selected by the selector 245 and stored in the holding FF 263 again as the transmission delay difference absorption information. In other words, the holding FF 263 continuously holds the same value. Note that, even when “11” is erroneously input to the selector 262 as the output value of the delay difference absorption state control decoder 2621, the line L12 is selected by the selector 245, and the holding FF 263 continuously holds the same value.

Here, more concrete operations performed by the pattern detecting circuit 25, the buffer 24, and the transmission delay difference absorption setting unit 26a which are configured as described above will be briefly described.

For example, when data of the lane [0] arrives earlier than data of the lane [1] by one clock, the count value obtained by the counter 255 of the lane [0] is “2”, and “001” is held in the holding FF 263 of the transmission delay difference absorption setting unit 26a of the lane [0]. Since the value in the holding FF 263 is used as the read pointer of the buffer 24, in the lane [0], the buffer 241 of the first stage is selected by the selector 245, and data is read from the buffer 241. Meanwhile, when “1” is counted, the counter 255 of the lane [1] receives the neighboring lane transmission delay difference information (the pattern detection signal of the lane [0]) from the AND gate 258, stops the counting operation, and holds “000” in the holding FF 263 of the transmission delay difference absorption setting unit 26a of the lane [1]. As a result, in the lane [1], the bypass line L0 is selected by the selector 245, and the data is read while bypassing the buffers 241 to 244.

[1-5-5] Configuration of Lane Control Unit 26b

FIG. 6 is a block diagram illustrating a configuration of the lane control unit 26b in the inter-lane transmission delay difference absorption control circuit 26.

As illustrated in FIG. 6, the lane control unit 26b includes determining circuits 2601 to 2612, flag holding registers 2613 to 2618, a first decoder 2619, a second decoder 2620, the third decoder 2621, an inverter 2622, and the OR gate 2623.

The determining circuits 2601 and 2602, the flag holding registers 2613 and 2614, and the first decoder 2619 are used in the outward path, and the determining circuits 2603 and 2604, the flag holding registers 2615 and 2616, and the second decoder 2620 are used in the return path. Further, the determining circuits 2605 to 2612, the flag holding registers 2617 and 2618, the third decoder 2621, the inverter 2622, and the OR gate 2623 are used in both the outward path and the return path.

First, a configuration used in the outward path will be described.

The determining circuit 2601 receives the lane enable signal LE1[1:0] and determines whether the signal LE1[1:0] is “01”, and sets a flag “current 1” to the flag holding register 2613 when it is determined that the signal LE1[1:0] is “01”. Note that, the lane enable signal LE1[1:0] is the lane enable signal LE2[1:0] of the neighboring lane [i−1] as described above.

When the flag “current 1” is set by the determining circuit 2601, the flag holding register 2613 outputs “1” as a signal sigA1. The clear signal CL1 is input to the flag holding register 2613, and when the clear signal CL1 is “1”, the flag holding register 2613 clears the flag “current 1” and outputs “0” as the signal sigA1. Note that, the clear signal CL1 is the clear signal CL2 of the neighboring lane [i+1] as described above. The flag “current 1” represents that its own lane [i] is selected as a lane pair in the outward path.

The determining circuit 2602 receives the output sigA1 of the flag holding register 2613 and the neighboring lane transmission delay difference information of the OR gate 26c, and determines whether the output sigA1 is “1” and the neighboring lane transmission delay information is “1”. When it is determined that the output sigA1 is “1” and the neighboring lane transmission delay information is “1”, the determining circuit 2602 sets the flag “complete 1” to the flag holding register 2614.

When the flag “complete 1” is set by the determining circuit 2602, the flag holding register 2614 outputs “1” as a signal sigA2. The flag “complete 1” represents that its own lane [i] has completed the transmission delay difference absorption process in the outward path.

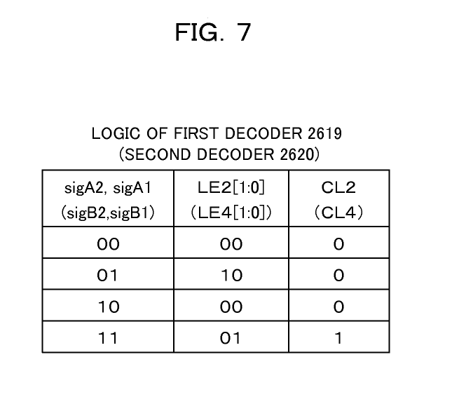

The first decoder (lane EN decoder 1) 2619 receives the signal sigA1 (current 1) from the register 2613 and the signal sigA2 (complete 1) from the register 2614, decodes the signals sigA1 and sigA2, and generates and outputs the lane enable signal LE2[1:0] and the clear signal CL2. Decoding content by the first decoder 2619, that is, a relation among the signals sigA1 and sigA2 and the output signals LE2[1:0] and CL2 is given in a logic (truth table) illustrated in FIG. 7. Note that, as described above, the lane enable signal LE2[1:0] is output as the lane enable signal LE1[1:0] of the neighboring lane [i+1], and the clear signal CL2 is output as the clear signal CL1 of the neighboring lane [i−1].

Next, a configuration used in the return path will be described.

The determining circuits 2603 and 2604, the flag holding registers 2615 and 2616, and the second decoder 2620 which are used in the return path correspond to the determining circuits 2601 and 2602, the flag holding registers 2613 and 2614, and the first decoder 2619 which are used in the outward path, respectively. The lane enable signals LE3[1:0] and LE4[1:0] correspond to the lane enable signals LE1[1:0] and LE2[1:0], respectively, and the clear signals CL3 and CL4 correspond to the clear signals CL1 and CL2, respectively. Further, flags “current 2” and “complete 2” correspond to the flags “current 1” and “complete 1”, respectively, and signals sigB1 and sigB2 correspond to the signals sigA1 and sigA2, respectively.

In other words, the determining circuit 2603 receives the lane enable signal LE3[1:0], determines whether the signal LE3[1:0] is “01”, and sets the flag “current 2” to the flag holding register 2615 when it is determined that the signal LE3[1:0] is “01”. Note that, the lane enable signal LE3[1:0] is the lane enable signal LE4[1:0] of the neighboring lane [i+1] as described above.

When the flag “current 2” is set by the determining circuit 2603, the flag holding register 2615 outputs “1” as the signal sigB1. The clear signal CL3 is input to the flag holding register 2615, and when the clear signal CL3 is “1”, the flag holding register 2615 clears the flag “current 2” and outputs “0” as the signal sigB1. Note that, the clear signal CL3 is the clear signal CL4 of the neighboring lane [i−1] as described above. The flag “current 2” represents that its own lane [i] is selected as a lane pair in the return path.

The determining circuit 2604 receives the output sigB1 of the flag holding register 2615 and the neighboring lane transmission delay difference information of the OR gate 26c, and determines whether the output sigB1 is “1” and the neighboring lane transmission delay information is “1”. The determining circuit 2604 sets the flag “complete 2” to the flag holding register 2616 when it is determined that the output sigB1 is “1” and the neighboring lane transmission delay information is “1”.

When the flag “complete 2” is set by the determining circuit 2604, the flag holding register 2616 outputs “1” as the signal sigB2. The flag “complete 2” represents that its own lane [i] has completed the transmission delay difference absorption process in the return path.

The second decoder (lane EN decoder 2) 2620 receives the signal sigB1 (current 2) from the register 2615 and the signal sigB2 (complete 2) from the register 2616, decodes the signals sigB1 and sigB2, and generates and outputs the lane enable signal LE4[1:0] and the clear signal CL4. Decoding content by the second decoder 2620, that is, a relation among the signals sigB1 and sigB2 and the output signals LE4[1:0] and CL4 is given in a logic (truth table) illustrated in FIG. 7. Here, when the second decoder 2620 uses the truth table illustrated in FIG. 7, the signals sigA1 and sigA2 are replaced with the signals sigB1 and sigB2, respectively, and the lane enable signal LE2[1:0] and the clear signal CL2 are replaced with the lane enable signal LE4[1:0] and the clear signal CL4, respectively. Note that, as described above, the lane enable signal LE4[1:0] is output as the lane enable signal LE3[1:0] of the neighboring lane [i−1], and the clear signal CL4 is output as the clear signal CL3 of the neighboring lane [i+1].

Next, a configuration used in both the outward path and the return path will be described.

The determining circuit 2605 receives the lane enable signal LE1[1:0], determines whether the signal LE1[1:0] is “01”, and sets a flag “Primary” to the flag holding register 2617 when it is determined that the signal LE1[1:0] is “01”.

The determining circuit 2606 receives the lane enable signal LE1[1:0], determines whether the signal LE1[1:0] is “00”, and clears the flag “Primary” of the flag holding register 2617 when it is determined that the signal LE1[1:0] is “00”.

The determining circuit 2607 receives the lane enable signal LE3[1:0], determines whether the signal LE3[1:0] is “01”, and sets the flag “Primary” to the flag holding register 2617 when it is determined that the signal LE3[1:0] is “01”.

The determining circuit 2608 receives the lane enable signal LE3[1:0], determines whether the signal LE3[1:0] is “00”, and clears the flag “Primary” of the flag holding register 2617 when it is determined that the signal LE3[1:0] is “00”.

The flag holding register (hereinafter, referred to as a “primary register”) 2617 is configured with a set priority FF so that a setting can be made when the lane enable signal LE1[1:0] or LE3[1:0] is “01”. The primary register 2617 outputs “1” when the flag “Primary” is set in the outward path by the determining circuit 2605 or when the flag “Primary” is set in the return path by the determining circuit 2607. The primary register 2617 outputs “0” when the flag “Primary” is cleared in the outward path by the determining circuit 2606 or when the flag “Primary” is cleared in the return path by the determining circuit 2608. The flag “Primary” represents that its own lane [i] is selected as a primary lane of a lane pair in the outward path or the return path, and a transmission delay difference is being adjusted.

The determining circuit 2609 receives the lane enable signal LE1[1:0], determines whether the signal LE1[1:0] is “10”, and sets a flag “Secondary” to the flag holding register 2618 when it is determined that the signal LE1[1:0] is “10”.

The determining circuit 2610 receives the lane enable signal LE1[1:0], determines whether the signal LE1[1:0] is “01”, and clears the flag “Secondary” of the flag holding register 2618 when it is determined that the signal LE1[1:0] is “01”.

The determining circuit 2611 receives the lane enable signal LE3[1:0], determines whether the signal LE3[1:0] is “10”, and sets the flag “Secondary” to the flag holding register 2618 when it is determined that the signal LE3[1:0] is “10”.

The determining circuit 2612 receives the lane enable signal LE3[1:0], determines whether the signal LE3[1:0] is “01”, and clears the flag “Secondary” of the flag holding register 2618 when it is determined that the signal LE3[1:0] is “01”.

The flag holding register (hereinafter, referred to as a “secondary register”) 2618 is configured with a clear priority FF and configured so that clearing is reliably performed. The secondary register 2618 outputs “1” when the flag “Secondary” is set in the outward path by the determining circuit 2609 or when the flag “Secondary” is set in the return path by the determining circuit 2611. The secondary register 2618 outputs “0” when the flag “Secondary” is cleared in the outward path by the determining circuit 2610 or when the flag “Secondary” is cleared in the return path by the determining circuit 2612. The flag “Secondary” represents that its own lane [i] is selected as a secondary lane of a lane pair in the outward path or the return path, and a transmission delay difference is being adjusted.

The third decoder (Decoder 3) 2621 functions as the delay difference absorption state control decoder illustrated in FIG. 5.

In other words, the third decoder 2621 generates a switching signal used to switch the selector 262 so that the transmission delay difference absorption information (an output from the delay detection counter 255 illustrated in FIG. 4) representing a transmission delay difference absorption amount of its own lane [i] is properly held in the holding FF 263 illustrated in FIG. 5.

Specifically, the third decoder 2621 outputs “00” in the first process (when its own lane [i] is a secondary lane in the outward path), selects an output of the subtracter 261, that is, the transmission delay value, and stores the transmission delay value in the holding FF 263. The third decoder 2621 outputs “01” in the second process (when its own lane [i] is a primary lane in the outward path), selects the sum of an output of the adder 264, that is, an output of the subtracter 261 and the value of the holding FF 263, and stores the sum in the holding FF 263. The third decoder 2621 outputs “01” in the third process (when its own lane [i] is a secondary lane in the return path), selects the sum of an output of the adder 264, that is, an output of the subtracter 261 and the value of the holding FF 263, and stores the sum in the holding FF 263. The third decoder 2621 outputs “01” in the fourth process (when its own lane [i] is a primary lane in the return path), selects the sum of an output of the adder 264, that is, an output of the subtracter 261 and the value of the holding FF 263, and stores the sum in the holding FF 263. When its own lane [i] is not selected as a lane pair, the third decoder 2621 outputs “10”, selects the line L12, and causes the same value as a currently held value to be held in the holding FF 263.

The third decoder 2621 is input the flags “current 1”, “complete 1”, “current 2”, “Primary”, and “Secondary” from the flag holding registers 2613 to 2615, 2617, and 2618 in order to output the switching signal used to switch the selector 262 as described above. Then, the third decoder 2621 decodes the flags, generates the switching signal, and outputs the switching signal to the selector 262. Content decoded by the third decoder 2621, that is, a relation among the flags “current 1”, “complete 1”, “current 2”, “Primary”, and “Secondary” and the switching signal is given in a logic (truth table) illustrated in FIG. 8.

The inverter 2622 inverts values of respective bits of the lane enable signal LE3[1:0] and outputs the inverted values.

The OR gate 2623 generates a logical sum of the lane enable signal LE1[1:0] and an inverting signal of the lane enable signal LE3[1:0] output from the inverter 2622, and outputs the logical sum as the lane select signal LS[1:0]. The lane select signal LS[1:0] is used as a signal that is used to switch the selector 257 and select the pattern detection signal of the neighboring lane [i+1] or [i−1] as described above with reference to FIG. 4.

The lane select signal LS[1:0] is “01” when its own lane [i] is a primary lane in the outward path (when the signal LE1[1:0] is “01”) or when its own lane [i] is a secondary lane in the return path (when the signal LE3[1:0] is “10”). The lane select signal LS[1:0] is “10” when its own lane [i] is a secondary lane in the outward path (when the signal LE1[1:0] is “10”) or when its own lane [i] is a primary lane in the return path (when the signal LE3[1:0] is “01”).

[2] Operation of Transmission Delay Difference Absorbing Device (Communication Device)

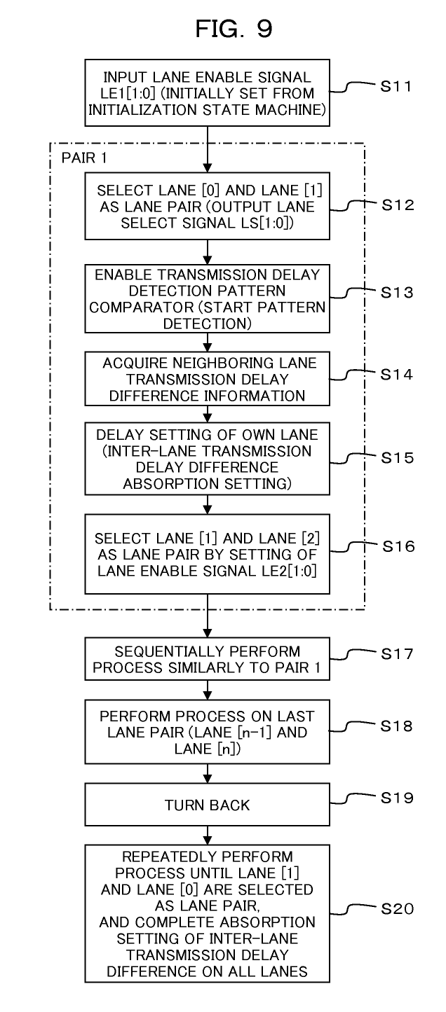

Next, a process performed by the transmission delay difference absorbing device (communication device) having the above-described configuration will be more concretely described with reference to FIGS. 9 to 37.

[2-1] Technique of Selecting Lane Pair

A technique of selecting a lane pair in the outward path will be described with reference to FIGS. 3 and 6. As described above, when two neighboring lanes are selected as a lane pair, for the sake of convenience, one of the two lanes is dealt as a primary lane, and the other is dealt as a secondary lane. The primary lane and the secondary lane are the same in an operation of performing the inter-lane transmission delay difference absorption process but different in content of the lane enable signal output from the lane control unit 26b to the neighboring lane.

In a lane to which the lane enable signal LE1[1:0]=“01” is input, the flag “Primary” is set to the primary register 2617, and the lane becomes a primary lane.

In a lane to which the lane enable signal LE1[1:0]=“10” is input, the flag “Secondary” is set to the secondary register 2618, and the lane becomes a secondary lane.

The primary lane outputs the lane enable signal LE2[1:0]=“10”. In other words, when the lane [i] is the primary lane, the lane enable signal LE2[1:0]=“10” of the lane [i] is input to the lane [i+1] as the lane enable signal LE1[1:0]=“10”, and the lane [i+1] becomes the secondary lane.

The secondary lane outputs the lane enable signal LE2[1:0]=“00”. In other words, when the lane [i+1] is the secondary lane, the lane enable signal LE2[1:0]=“00” of the lane [i+1] is input to the lane [i+2] as the lane enable signal LE1[1:0]=“00”. A lane to which the lane enable signal LE1[1:0]=“00” is input is deactivated, is not set as a lane pair, and excluded from a target of the inter-lane transmission delay difference absorption process.

For example, the 2-bit lane enable signal LE2[1:0] of the control circuit 26 of the lane [0] is connected to a 2-bit lane enable signal LE1[1:0] of the control circuit 26 of the lane [1]. In the lane enable signals LE2[1:0] and LE1[1:0], a bit [0] is a bit representing a primary lane, and a bit [1] is a bit representing a secondary lane.

[2-2] Inter-Lane Transmission Delay Difference Absorption Setting Process

An inter-lane transmission delay difference absorption setting process performed by the transmission delay difference absorbing device (communication device) according to the present embodiment will be described with reference to a flowchart (steps S11 to S20) illustrated in FIG. 9.

When the inter-lane transmission delay difference absorption setting process starts, first of all, the lane enable signal LE1[1:0]=“01” is input from the initialization state machine 20b to the lane control unit 26b of the lane [0] (step S11). As a result, the lane [0] is set as a primary lane.

The lane control unit 26b of the lane [0] set as the primary lane outputs the lane enable signal LE2[1:0]=“10” to the lane [1]. Since the lane enable signal LE2[1:0] of the lane [0] is connected to the lane enable signal LE1[1:0] of the lane [1], the lane enable signal LE1[1:0] of the lane [1] is “10”, and the lane [1] is set as a secondary lane. As a result, the lanes [0] and [1] are selected as a lane pair 1 (step S12). The lane control unit 26b of the lane [1] set as the secondary lane outputs the lane enable signal LE2[1:0]=“00” to the lane [2], and deactivates the lane [2].

When the lanes [0] and [1] are selected as the lane pair 1, in the lane [0], the lane select signal LS[1:0]=“01” is output from the lane control unit 26b to the selector 257 of the pattern detecting circuit 25. Further, in the lane [1], the lane select signal LS[1:0]=“10” is output from the lane control unit 26b to the selector 257 of the pattern detecting circuit 25. Further, in the lanes [0] and [1], since an output of the determining circuit 253 is “1”, a comparison result of the comparator 252 is able to pass through the AND gate 254, and the comparator 252 is enabled (step S13).

In the state in which the comparator 252 is enabled, data including a specific pattern is transmitted from the transmitting module 10 to the receiving module 20. At this time, only in the lanes [0] and [1] in which the comparator 252 is enabled, the delay detection counter 255 is activated, and in each of the lanes [0] and [1], the neighboring lane transmission delay difference information is acquired, and a transmission delay difference is measured and stored in the holding FF 263 (step S14). Then, the transmission delay difference stored in the holding FF 263 is output to the selector 245 of the buffer 24 as the delay setting information of its own lane [i] and used as the read pointer of the buffer 24 (step S15).

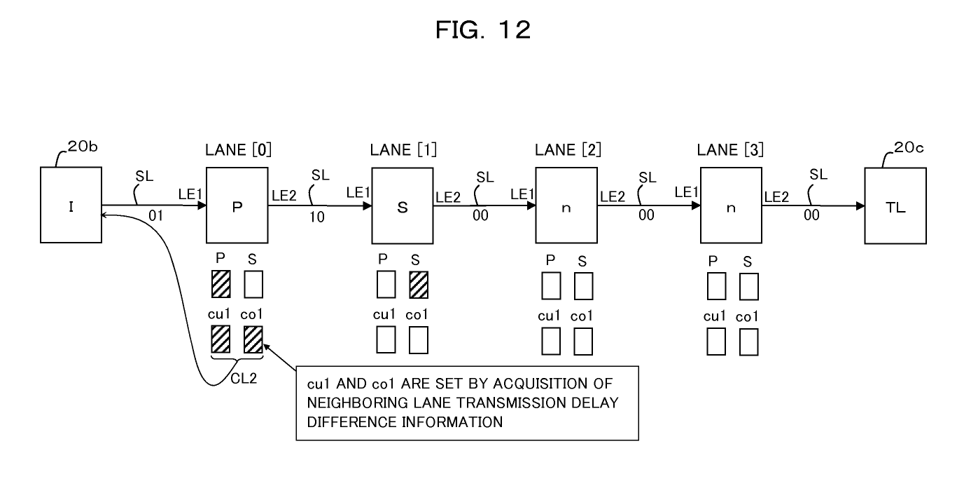

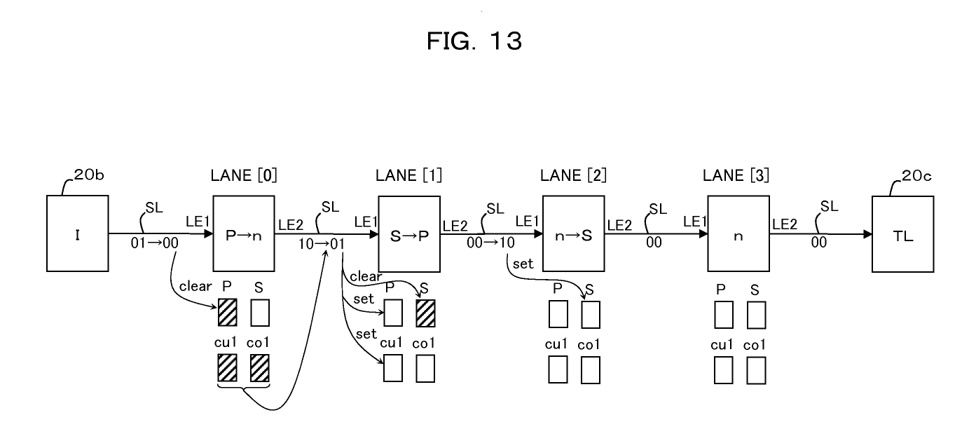

Thereafter, in order to select the lanes [1] and [2] as a lane pair, the lane enable signals LE2[1:0] of the lanes [0] and [1] is set (step S16). In other words, when a transmission delay difference absorption setting between the lanes [0] and [1] ends, the lane control unit 26b of the lane [0] transmits the clear signal CL2 to the initialization state machine 20b (see FIG. 12). As a result, the lane enable signal LE1[1:0] output from the initialization state machine 20b changes from “01” to “00”, the lane enable signal LE2[1:0] of the lane [0] changes from “10” to “01”, and the lane enable signal LE2[1:0] of the lane [1] changes from “00” to “10” (see FIG. 13). Thus, the lane [1] is set as a primary lane, and the lane [2] is set as a secondary lane.

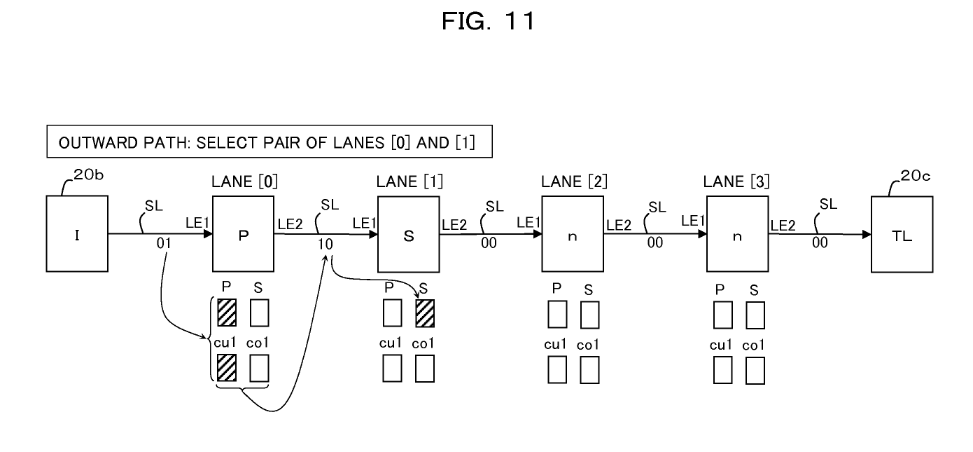

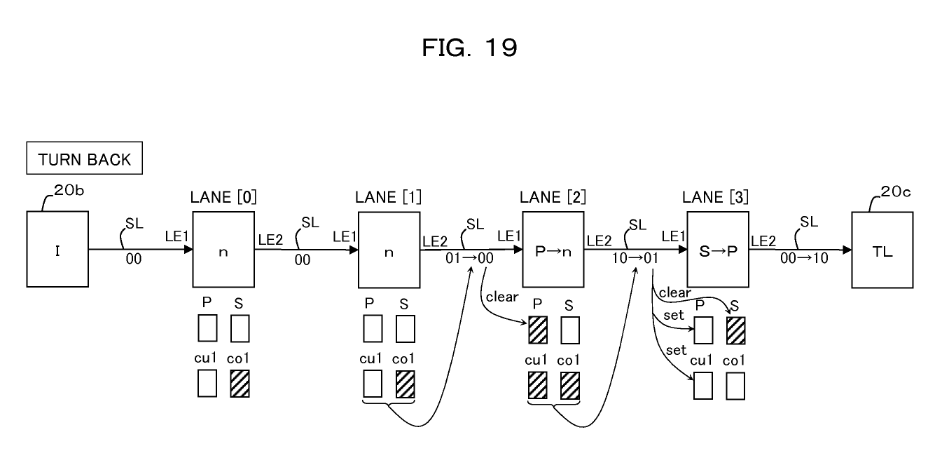

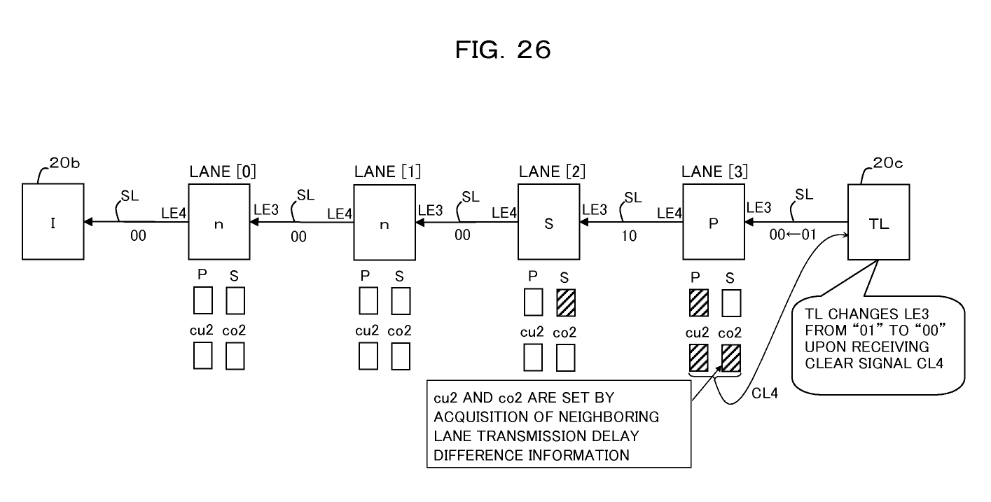

The lane control unit 26b of each lane [i] exchanges the lane enable signals LE1[1:0] and LE2[1:0] and the clear signals CL1 and CL2 with the neighboring lane as will be described below with reference to FIGS. 11 to 18. Thus, a shift selection of a lane pair is performed until the lanes [n−1] and [n] is selected as a lane pair in the outward path, and each time a lane pair is selected, the transmission delay difference absorption process (correction process) is performed (steps S17 and S18). Thereafter, the turn-back operation of the lane pair selection is performed by the termination logic 20c as will be described later with reference to FIGS. 19 to 25 (step S19). Further, the lane control unit 26b of each lane [i] exchanges the lane enable signals LE3[1:0] and LE4[1:0] and the clear signals CL3 and CL4 with the neighboring lane as will be described later with reference to FIGS. 26 to 37. As a result, in the return path, a lane pair is sequentially shifted and selected from the lanes [n] and [n−1] to the lanes [1] and [0], and each time a lane pair is selected, the transmission delay difference absorption process is performed (step S20). Note that, after turning back, since the absorption process on the first lane pair [n] and [n−1] overlaps the absorption process on the last lane pair [n−1] and [n] in the outward path, the absorption process may start from the lanes [n−1] and [n−2].

[2-3] Concrete Example of Inter-Lane Transmission Delay Difference Absorption Setting Process

Each of the primary lane and the secondary lane selected as a lane pair receives the pattern detection signals of the both, and decides the delay setting information (see outputs of the setting units 26a of FIGS. 4 and 5) of its own lane based on the neighboring lane transmission delay difference information (see an output of the AND gate 258 of FIG. 4). Here, a concrete example of the transmission delay difference information of the neighboring lane and the inter-lane transmission delay difference absorption setting process will be described with reference to FIGS. 10A to 10F. Note that, FIGS. 10A to 10F schematically illustrate transmission data transmitted by a transmission device configured with four serial lanes [0] to [3].

A time difference occurs between data arriving at the reception side in the respective lanes due to a line length difference in a transmission path or a manufacturing variation of a device between a transmitting and a receiver. In the case in which data is sampled using a clock of a reception side, when data is sampled at the same clock edge in neighboring lanes, it is recognized that there is no time difference. However, when data is sampled at different clock edges in neighboring lanes, it is recognized that there is a time difference.

FIGS. 10A to 10F illustrate a form of reception data which have been sampled using a clock of a reception side. Note that, in the drawings, each of letters A to H represents 1-bit data which is synchronized between lanes, that is, which is to be received at the same timing (clock edge).

FIG. 10A illustrates a state before the transmission delay difference absorption setting process is performed. In a lane configuration illustrated in FIG. 10A, lanes having the shortest line length are lanes [1] and [3], and a lane having the longest line length is a line [2]. Further, there is a difference corresponding to a 1 bit, that is, a 1 clock between data of the lane [0] and data of the lane [1], and data of the lane [0] arrives later than data of the lane [1] with a 1-clock delay. There is a difference corresponding to 2 bits, that is, 2 clocks between data of the lane [1] and data of the lane [2], and data of the lane [1] arrives earlier than data of the lane [1] by 2 clocks. There is a difference corresponding to 2 bits, that is, 2 clocks between data of the lane [2] and data of the lane [3], and data of the lane [2] arrives later than data of the lane [3] with a 2-clock delay. Such a clock difference is used as the transmission delay difference absorption information.

When the inter-lane the transmission delay difference absorption process according to the present embodiment is performed on the lane configuration illustrated in FIG. 10A, the read-out timings (the read pointers) of the respective lanes [0], [1], and [3] from the buffer 24 are adjusted and set such that a reception timing of the lane [2] having the longest line length matches the reception timing of the other lanes [0], [1], and [3] in the following manner.

When the setting process of correcting the transmission delay difference is performed on the lane configuration illustrated in FIG. 10A, first, the primary lane [0] and the secondary lane [1] are selected as a lane pair, and the setting process is performed on the lanes [0] and [1] as illustrated in FIG. 10B. At this time, since the lane [1] is shorter in the line length than the lane [0] and data of the lane [1] arrives at the reception side earlier than data of the lane [0], pattern detection in the lane [1] is performed prior to pattern detection in the lane [0]. The lane [1] receives the pattern detection signal from the lane [0] when “2” is counted by the counter 255 of the lane [1], and generates the neighboring lane transmission delay difference information through the AND gate 258. The lane [0] first receives the pattern detection signal of the lane [1] side as the pattern detection signal of the neighboring lane B, the pattern detection signal of its own lane [0] after a 1 clock, and generates the neighboring lane transmission delay difference information through the AND gate 258. At this point in time, the count value obtained by the counter 255 of the lane [0] is “1”, and the count value obtained by the counter 255 of the lane [2] is “2”.

At this time, data of the lane [0] arrives later than data of the lane [1] with a 1-clock delay as illustrated in FIG. 10A. The delay is also detected by the pattern detecting units 25a of the lanes [0] and [1] with a 1-clock delay. The neighboring lane transmission delay difference information which is a logical product of the pattern detection signals of the lanes [0] and [1] generated by the AND gate 258 is used as a signal stopping the delay detection counter 255 of its own lane as illustrated in FIG. 4. In other words, the counting operation started by the counter 255 when the transmission delay difference detection pattern is detected is stopped by the neighboring lane transmission delay difference information. Thus, when data of an earlier lane is delayed more or less based on a count value in an earlier lane of a lane pair, it is possible to decide whether reception timing of data of both lanes can match each other. In the present embodiment, the count value obtained by the counter 255 is used as the transmission delay difference absorption information illustrated in FIG. 4. This information is decided in each lane. For example, when data of the lane [0] arrives earlier than data of the lane [1] by a 1 clock, the count value of the lane [0] is larger than the count value of the lane [1] by 1 (one). On the other hand, when data of the lane [1] arrives earlier than data of the lane [0] by a 1 clock, the count value of the lane [1] is larger than the count value of the lane [0] by 1 (one). Further, when data of the lane [0] and data of the lane [1] arrive at the same time, the count values of both lanes include the same values. The delay setting information based on the count value is set as the read pointer of the inter-lane transmission delay difference absorbing buffer 24, such that a setting for correcting an inter-lane transmission delay difference is performed.

Meanwhile, the count values in the each lane of the lane pair are transferred to the transmission delay difference absorption setting units 26a of their own lanes in the control circuits 26 of the respective lanes as the transmission delay difference absorption information. In the transmission delay difference absorption setting unit 26a, a value obtained by subtracting “1” from the count value by the counter 255 is held in the holding FF 263. For example, when the setting process of correcting the transmission delay difference is performed on the lane pair [0] and [1] illustrated in FIG. 10B, “000” is held in the holding FF 263 of the lane [0], and “001” is held in the holding FF 263 of the lane [1]. The delay setting information held in the holding FF 263 of each of the lanes [0] and [1] is used as the read pointer of the buffer 24 of each lane, and the selector 245 selects and outputs data from one of the lines L0 to L4 corresponding to the read pointer. Thus, the line L0 is selected in the buffer 24 of the lane [0], and the selector 245 outputs data as it is without any delay (see data A to H of the lane [0] in FIG. 10B). Further, the line L1, that is, the buffer 241 of the first stage is selected in the buffer 24 of the lane [1], and the selector 245 outputs data with a 1-clock delay compared to data of the lane [0] (see data A′˜H′ of the lane [1] in FIG. 10B).

Next, as illustrated in FIG. 10C, the primary lane [1] and the secondary lane [2] are selected as a lane pair, and the above-described setting process is performed on the lanes [1] and [2]. In this case, in the primary lane [1], the output value of the third decoder 2621 of the lane control unit 26b is “01” (see FIG. 8), and the selector 262 selects an output of the adder 264. For this reason, in the lane [1], a delay value “001” obtained by the subtracter 261 in the current process is added to a value “001” previously held in the holding FF 263 by the adder 264, and the addition value “010” is held in the holding FF 263 of the lane [1]. Meanwhile, in the secondary lane [2], the output value of the third decoder 2621 of the lane control unit 26b is “00” (see FIG. 8), and the selector 262 selects an output of the subtracter 261. Thus, “000” is held in the holding FF 263 of the lane [2]. Thus, in the buffer 24 of the lane [1], the line L2, that is, the buffer 242 of the second stage is selected, and the selector 245 outputs data with a 1-clock delay compared to data of the lane [2] (see data A′ to H′ of the lane [1] in FIG. 10C). Further, in the buffer 24 of the lane [2], the line L0 is selected, and the selector 245 outputs data as it is without any delay (see data A to H of the lane [2] in FIG. 10C).

Next, as illustrated in FIG. 10D, the primary lane [2] and the secondary lane [3] are selected as a lane pair, and the above-described setting process is performed on the lanes [2] and [3]. In this case, in the primary lane [2], the output value of the third decoder 2621 of the lane control unit 26b is “01” (see FIG. 8), and the selector 262 selects an output of the adder 264. For this reason, in the lane [2], a delay value “000” obtained by the subtracter 261 in the current process is added to a value “000” previously held in the holding FF 263 by the adder 264, and the addition value “000” is held in the holding FF 263 of the lane [2]. Meanwhile, in the secondary lane [3], the output value of the third decoder 2621 of the lane control unit 26b is “00” (see FIG. 8), and the selector 262 selects an output of the subtracter 261. Thus, in the lane [3], the subtracter 261 subtracts 1 from the count value “011” from the counter 255, and the subtracted value “010” is held in the holding FF 263. Further, in the buffer 24 of the lane [2], the line L0 is selected, and the selector 245 outputs data as it is without any delay (see data A to H of the lane [2] in FIG. 10D). Further, in the buffer 24 of the lane [3], the line L2, that is, the buffer 242 of the second stage is selected, and the selector 245 outputs data with a 2-clock delay compared to the data of the lane [2] (see data A′ to H′ of the lane [3] in FIG. 10D).

Through the above-described setting process, the setting process of correcting the transmission delay difference is performed on all the lanes [0] to [3]. However, actually, the lane [0] remains in the state of receiving data earlier than the other lanes [1] to [3] by a 1 clock as illustrated in FIGS. 10D to 10F. In order to prevent the setting process from ending in this state, the above-described setting process is performed not only in the outward path while shifting a lane pair from the lane [0] to the lane [3] but also in the return path while shifting a lane pair from the lane [3] to the lane [0] as will be described later. As the setting process is reciprocated once, the setting process of the read pointer is performed to correct the transmission delay difference of all the lanes [0] to [3]. Note that, the flag “complete 1” representing that the setting process of the outward path has been completed is set to the lane control units 26b of the respective lanes [0] to [3] serving as the setting process target of the return path.

Next, as illustrated in FIG. 10D, the primary lane [3] and the secondary lane [2] are selected as a lane pair, and the second setting process (of the return path) is performed. At this time, since the lanes [3] and [2] are already set to the state having no transmission delay difference therebetween, the transmission delay difference absorption information of the counter 255 in both of the lanes [3] and [2] is “001”. A value obtained by subtracting “1” from the transmission delay difference absorption information “001” through the subtracter 261 is “000”. Here, in both of the lanes [3] and [2], the output value of the third decoder 2621 of the lane control unit 26b is “01” (see FIG. 8), and the selector 262 selects an output of the adder 264. Thus, in the lane [3], “010” is continuously held in the holding FF 263, and in the lane [2], “000” is continuously held in the holding FF 263.

Then, as illustrated in FIG. 10E, the primary lane [2] and the secondary lane [1] are selected as a lane pair, and the second setting process (of the return path) is performed. At this time, since the lanes [2] and [1] are already set to the state having no transmission delay difference therebetween, the transmission delay difference absorption information of the counter 255 in both of the lanes [2] and [1] is “001”. A value obtained by subtracting “1” from the transmission delay difference absorption information “001” through the subtracter 261 is “000”. Here, in both of the lanes [2] and [1], the output value of the third decoder 2621 of the lane control unit 26b is “01” (see FIG. 8), and the selector 262 selects an output of the adder 264. Thus, in the lane [2], “000” is continuously held in the holding FF 263, and in the lane [1], “010” is continuously held in the holding FF 263.

Lastly, as illustrated in FIG. 10F, the primary lane [1] and the secondary lane [0] are selected as a lane pair, and the second setting process (of the return path) is performed. At this time, since data of the lane [0] is received earlier than data of the lane [1] by a 1 clock, the count value by the counter 255 of the lane [1] is “001”, and the count value by the counter 255 of the lane [0] is “010”. Here, in both of the lanes [1] and [0], the output value of the third decoder 2621 of the lane control unit 26b is “01” (see FIG. 8), and the selector 262 selects an output of the adder 264. Thus, in the lane [1], the value “000” obtained by subtracting “1” from the count value “001” by the subtracter 261 is added to the value “010” previously held in the holding FF 264 by the adder 264, and the addition value “010” is held in the holding FF 263. Further, in the lane [0], the value “001” obtained by subtracting “1” from the count value “010” is added to the value “000” held in the holding FF 264 by the adder 264, and the addition value “001” is held in the holding FF 263. Thus, in the buffer 24 of the lane [1], the line L2, that is, the buffer 242 of the second stage is selected, and the selector 245 outputs data with a 2-clock delay compared to the data of the lane [2] (see data A to H of the lane [1] in FIG. 10F). Further, in the buffer 24 of the lane [0], the line L1, that is, the buffer 241 of the first stage is selected, and the selector 245 outputs data with a 1-clock delay compared to the data of the lane [2] (see data A′ to H′ of the lane [0] in FIG. 10F).

As the above-described setting process is performed, in the lane configuration illustrated in FIG. 10A, “001” is held in the holding FF 263 of the lane [0], “010” is held in the holding FF 263 of the lane [1], “000” is held in the holding FF 263 of the lane [2], and “010” is held in the holding FF 263 of the lane [3]. Then, the buffer stage number in the buffer 24 is selected according to the value held in each holding FF 263. As a result, the read-out timing (the read pointers) of the lanes [0], [1], and [3] from the buffer 24 are adjusted and set such that a reception timing of the lane [2] having the longest line length matches the reception timing of the other lanes [0], [1], and [3].

[2-4] Concrete Example of Lane Pair Selection Operation

Lane pair selection operations (1) to (27) in the transmission delay difference absorbing device (communication device) according to the present embodiment will be concretely described with reference to FIGS. 11 to 37.

FIGS. 11 to 37 concretely illustrate the lane pair selection operations (1) to (27) when the transmission delay difference absorbing device (communication device) according to the present embodiment is applied to a device provided with the initialization state machine (I) 20b, the termination logic (TL) 20c, and the four lanes [0] to [3].

Particularly, FIGS. 11 to 18 illustrate the operations (1) to (8) until the lanes [0] and [1], the lanes [1] and [2], and the lanes [2] and [3] are sequentially shifted and selected as a lane pair in the outward path after the setting process of correcting the transmission delay difference among the lanes [0] to [3] starts. FIGS. 19 to 25 illustrate turn-back operations (9) to (15) of lane pair selection. FIGS. 26 to 37 illustrate operations (16) to (27) until the lanes [3] and [2], the lanes [2] and [1], and the lanes [1] and [0] are sequentially shifted and selected as a lane pair in the return path after turning back, and the setting process is completed.

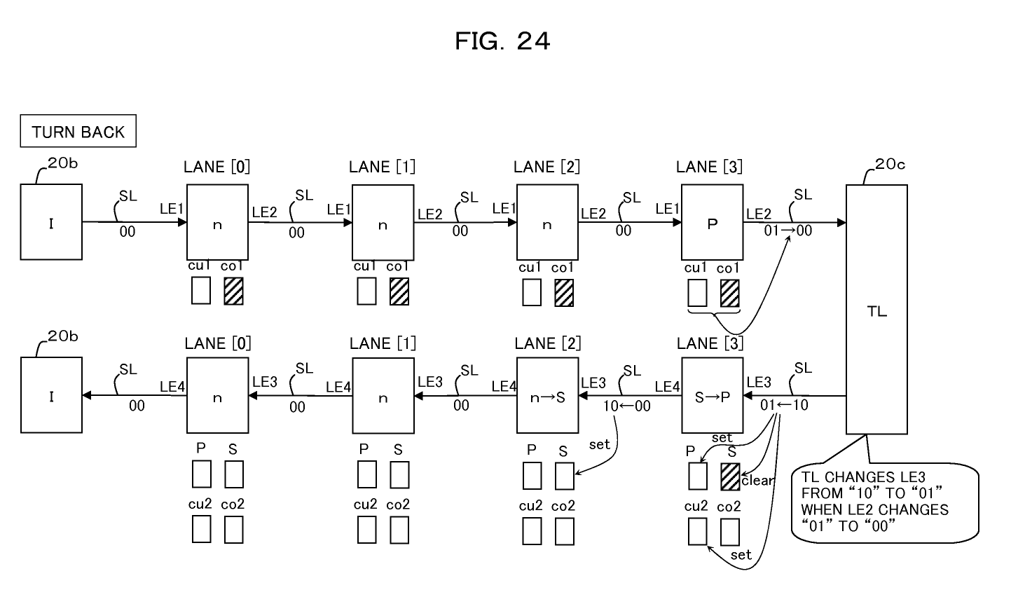

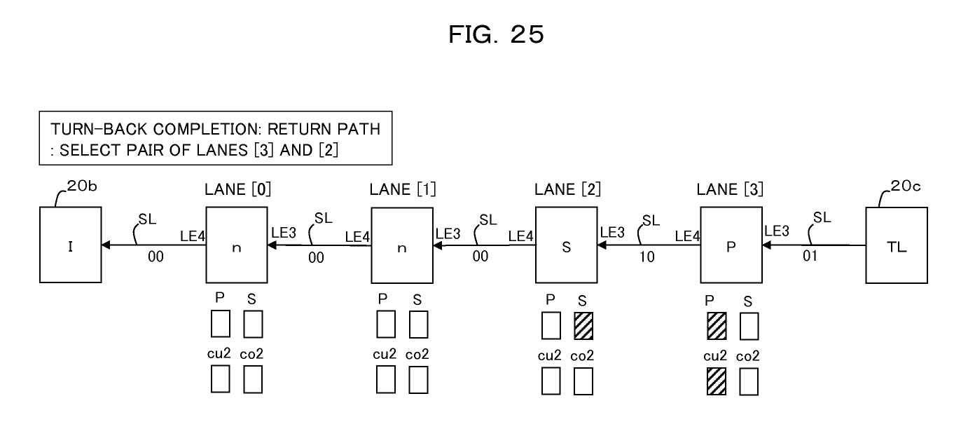

Note that, setting states of the flags “Primary”, “Secondary”, “current 1”, “complete 1”, “current 2”, and “complete 2” in each lane (the flag holding registers 2613 to 2618 of the lane control unit 26b) in each of the operation stages (1) to (27) are indicated in the lanes [0] to [3] of each drawing. Specifically, in FIGS. 11 to 37, in each lane, the states of the flags “Primary”, “Secondary”, “current 1”, “complete 1”, “current 2”, and “complete 2” are indicated by blocks P, S, cu1, co1, cu2, and co2. Further, when a flag is set, a corresponding block is hatched, and when a flag is not set (cleared), a corresponding block remains blank. Further, in FIGS. 11 to 22, the flags “current 2” and “complete 2” are not illustrated in each lane, but all of these flags are in a non-setting state. In FIGS. 25 to 37, the flags “current 1” and “complete 1” are not illustrated in each lane, but as illustrated in FIG. 24, the flag “current 1” is all cleared, and the flag “complete 1” is all set.

Further, in the transmission device illustrated in FIGS. 11 to 37, the four lanes [0] to [3] are connected in serial (the beaded form) to one another through the signal line SL between the initialization state machine 20b and the termination logic 20c, similarly to the device illustrated in FIGS. 1 to 3. Further, in FIGS. 11 to 37, states (2-bit data) of the lane enable signals LE1[1:0] and LE2[1:0] respectively input and output to the initialization state machine 20b, the lanes [0] to [3], and the termination logic 20c in each of the operation stages (1) to (27) are indicated below the signal lines SL connecting the initialization state machine 20b, the lanes [0] to [3], and the termination logic 20c.

Further, in FIGS. 11 to 37, one of symbols “P”, “S”, and “n” representing the state of each lane in each of the operation stages (1) to (27) is written in a block representing each of the lanes [0] to [3]. Here, when “P” is written, it means that a lane in which “P” is written is selected as a primary lane of a lane pair. When “S” is written, it means that a lane in which “S” is written is selected as a secondary lane of a lane pair. When “n” is written, it means that a lane in which “n” is written is not selected as a lane pair, that is, the lane is deactivated.

First of all, the lane pair selection operations (1) to (8) in the outward path will be described with reference to FIGS. 11 to 18.

In the operation (1) illustrated in FIG. 11, when the inter-lane transmission delay difference absorption setting process starts, the lane enable signal LE1[1:0]=“01” is first input from the initialization state machine 20b to the lane [0]. As a result, the flags P and cu1 are set in the lane [0], and the lane [0] is set as a primary lane. The lane [0] set as the primary lane outputs the lane enable signal LE2[1:0]=“10” to the lane [1], and the same signal is input as the lane enable signal LE1[1:0]=“10” of the lane [1]. Through this operation, the flag S is set in the lane [1], the lane [1] is set as a secondary lane, and thus the lanes [0] and [1] are selected as a lane pair. The lane [1] set as the secondary lane outputs the lane enable signal LE2[1:0]=“00” to the lane [2], and the subsequent lanes [2] and [3] are deactivated.

In the operation (2) illustrated in FIG. 12, when the lanes [0] and [1] receive the neighboring lane transmission delay difference information from each other after the operation (1), that is, when the primary lane [0] completes the setting process in the outward path, the flag co1 is set in the lane [0], and both of the flags cu1 and co1 are set in the lane [0]. As a result, the lane [0] transmits the clear signal CL2 to the initialization state machine 20b.

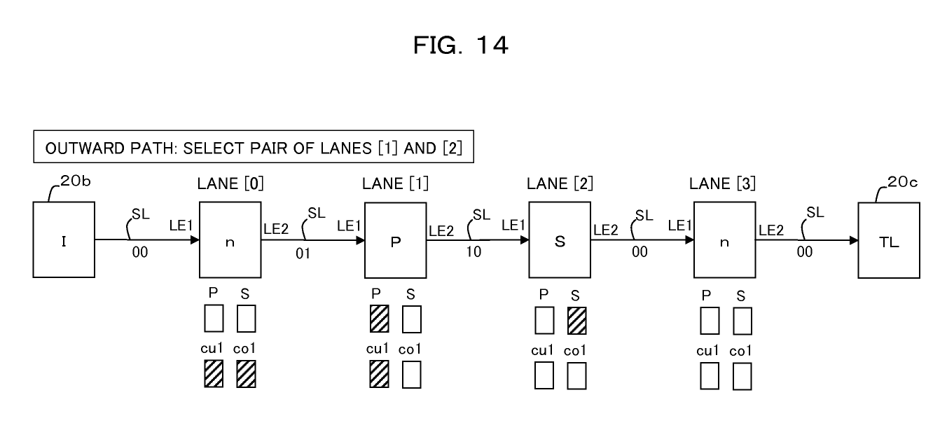

In the operations (3) and (4) illustrated in FIGS. 13 and 14, when the initialization state machine 20b receives the clear signal CL2 from the lane [0], the lane enable signal LE1[1:0] input from the initialization state machine 20b to the lane [0] changes from “01” to “00”. As a result, the flag P of the lane [0] is cleared. Further, as both of the flags cu1 and co1 are set in the lane [0] in the operation (2), the lane enable signal LE1[1:0] input from the lane [0] to the lane [1] changes from “10” to “01”. When the lane enable signal LE1[1:0]=“01” is input to the lane [1], the flags P and cu1 are set in the lane [1], the flag S is cleared, and the lane enable signal LE1[1:0] input from the lane [1] to the lane [2] changes from “00” to “10”. When the lane enable signal LE1[1:0]=“10” is input to the lane [2], the flag S is set in the lane [2]. Thus, the lane [0] is deactivated, and a lane pair having the lane [1] as a primary lane and the lane [2] as a secondary lane is selected as illustrated in FIG. 14. Note that, thereafter, the initialization state machine 20b is on standby until the lane enable signal LE4[1:0] from the lane [0] changes from “00” to “10”.

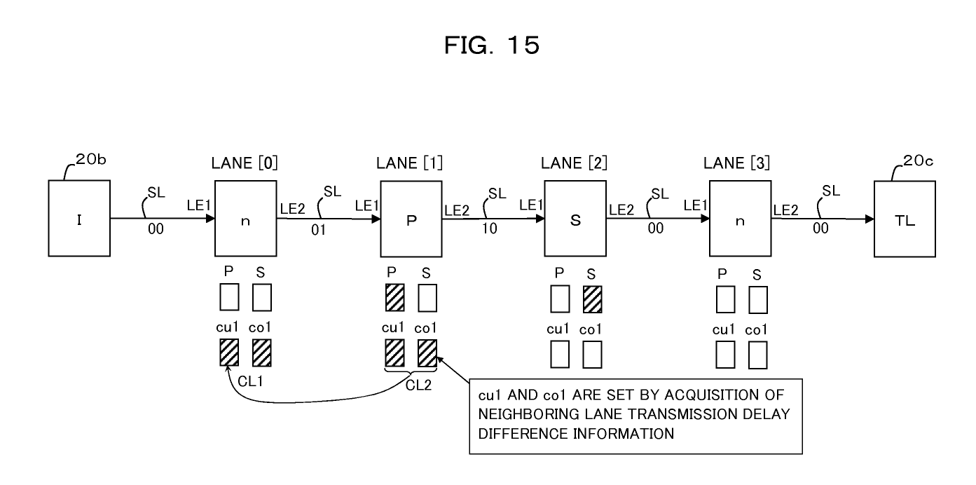

In the operation (5) illustrated in FIG. 15, when the lanes [1] and [2] receive the neighboring lane transmission delay difference information from each other after the operation (4), that is, when the primary lane [1] completes the setting process in the outward path, the flag co1 is set in the lane [1], and both of the flags cu1 and co1 are set in the lane [1]. As a result, the lane [1] outputs the clear signal CL2 to the lane [0], and the same clear signal CL2 is input as the clear signal CL1 of the lane [0].

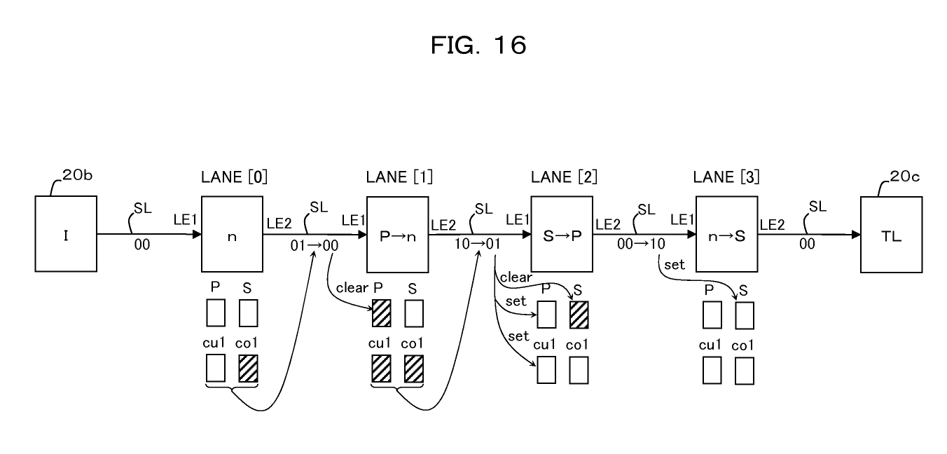

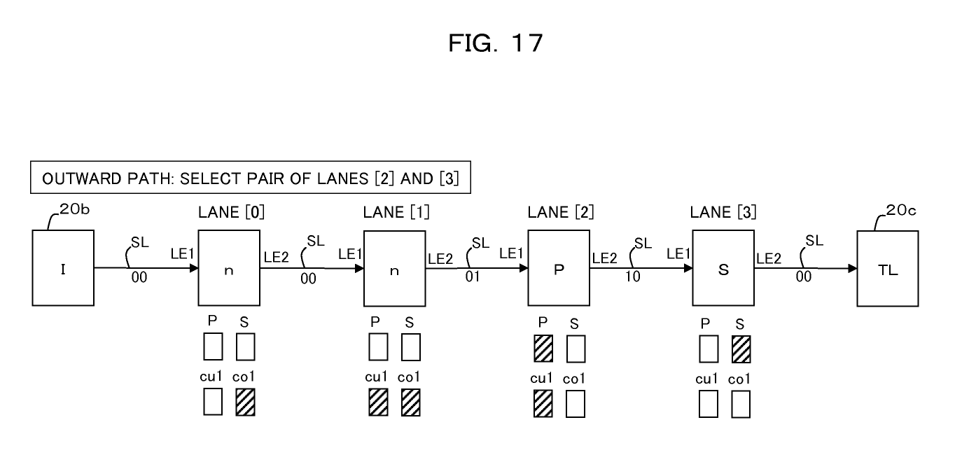

In the operations (6) and (7) illustrated in FIGS. 16 and 17, when the lane [0] receives the clear signal CL1 from the lane [1], the flag cu1 of the lane [0] is cleared. According to this operation, the lane enable signal LE1[1:0] input from the lane [0] to the lane [1] changes from “01” to “00”. As a result, the flag P of the lane [1] is cleared. Further, as both of the flags cu1 and co1 are set in the lane [1] in the operation (5), the lane enable signal LE1[1:0] input from the lane [1] to the lane [2] changes from “10” to “01”. When the lane enable signal LE1[1:0]=“01” is input to the lane [2], the flags P and cu1 are set in the lane [2], the flag S is cleared, and the lane enable signal LE1[1:0] input from the lane [2] to the lane [3] changes from “00” to “10”. When the lane enable signal LE1[1:0]=“10” is input to the lane [3], the flag S is set in the lane [3]. As a result, the lane [1] is deactivate, and a lane pair having the lane [2] as a primary lane and the lane [3] as a secondary lane is selected as illustrated in FIG. 17.

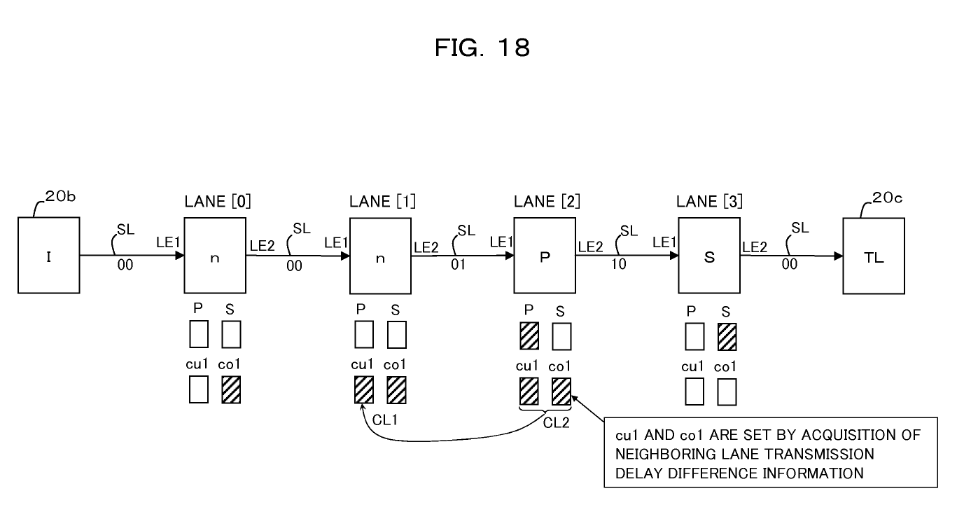

In the operation (8) illustrated in FIG. 18, when the lanes [2] and [3] receive the neighboring lane transmission delay difference information from each other after the operation (7), that is, when the primary lane [2] completes the setting process in the outward path, the flag co1 is set in the lane [2], and both of the flags cu1 and co1 are set in the lane [2]. As a result, the lane [2] outputs the clear signal CL2 to the lane [1], and the same clear signal CL2 is input as the clear signal CL1 of the lane [1].

Next, the turn-back operation of lane pair selection, that is, the operations (9) to (15) of switching the lane pair selection from the outward path to the return path will be described with reference to FIGS. 19 to 25.

In the operations (9) and (10) illustrated in FIGS. 19 and 20, when the lane [1] receives the clear signal CL1 from the lane [2], the flag cu1 of the lane [1] is cleared. According to this operation, the lane enable signal LE1[1:0] input from the lane [1] to the lane [2] changes from “01” to “00”. As a result, the flag P of the lane [2] is cleared. Further, as both of the flags co1 and co1 are set in the lane [2] in the operation (8), the lane enable signal LE1[1:0] input from the lane [2] to the lane [3] changes from “10” to “01”. When the lane enable signal LE1[1:0]=“01” is input to the lane [3], the flags P and cu1 are set in the lane [3], and the flag S is cleared. As a result, the lane [2] is deactivated, and the lane [3] is set as the primary lane as illustrated in FIG. 20.

Then, in the operation (10) illustrated in FIG. 20, when the lane enable signal LE1[1:0]=“10” is input to the termination logic 20c, the termination logic 20c inputs the set signal SC1 for setting the flag co1 of the lane [3] to the lane [3] as the neighboring lane transmission delay information.

In the operation (11) illustrated in FIG. 21, when the lane [3] receives the set signal SC1 from the termination logic 20c, the flag co1 is set in the lane [3], and both of the flags cu1 and co1 are set in the lane [3]. As a result, the lane [3] outputs the clear signal CL2 to the lane [2], and the same clear signal CL2 is input as the clear signal CL1 of the lane [2].

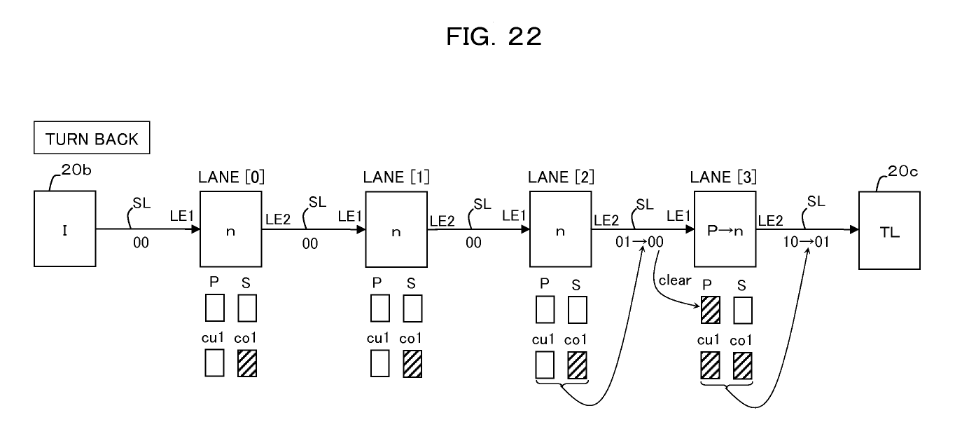

In the operation (12) illustrated in FIG. 22, when the lane [2] receives the clear signal CL1 from the lane [3], the flag co1 of the lane [2] is cleared. According to this operation, the lane enable signal LE1[1:0] input from the lane [2] to the lane [3] changes from “01” to “00”. As a result, the flag P of the lane [3] is cleared. Further, as both of the flags cu1 and co1 are set in the lane [3] in the operation (11), the lane enable signal LE2[1:0] input from the lane [3] to the termination logic 20c changes from “10” to “01”.

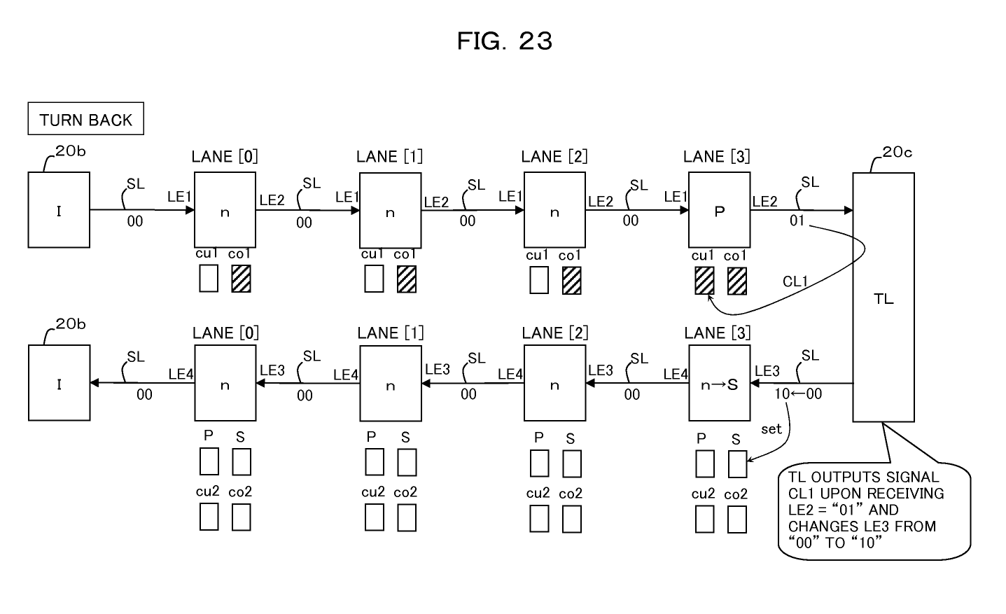

Then, in the operation (13) illustrated in FIG. 23, when the lane enable signal LE1[1:0]=“01” is input to the termination logic 20c, the termination logic 20c inputs the clear signal CL1 to the lane [3], and changes the lane enable signal LE3[1:0] input to the lane [3] from “00” to “10”. As a result, the flag cu1 of the lane [3] is cleared, and the flag S is set in the lane [3].

In the operations (14) and (15) illustrated in FIGS. 24 and 25, when the flag cu1 of the lane [3] is cleared, the lane enable signal LE2[1:0] input from the lane [3] to the termination logic 20c changes from “01” to “00”. As a result, the termination logic 20c changes the lane enable signal LE3[1:0] input to the lane [3] from “10” to “01”. When the lane enable signal LE3[1:0]=“01” is input to the lane [3], the flags P and cu2 are set in the lane [3], the flag S is cleared, and the lane enable signal LE3[1:0] input from the lane [3] to the lane [2] changes from “00” to “10”. When the lane enable signal LE3[1:0]=“10” is input to the lane [2], the flag S is set in the lane [2]. As a result, a lane pair having the lane [3] as a primary lane and the lane [2] as a secondary lane is selected as illustrated in FIG. 25. Through the operations above, the lane pair selection is turned back.

Next, the lane pair selection operations (16) to (27) in the return path will be described with reference to FIGS. 26 to 37.

In the operation (16) illustrated in FIG. 26, when the lanes [3] and [2] receive the neighboring lane transmission delay difference information from each other after the operation (15), that is, when the primary lane [3] completes the setting process in the return path, the flag co2 is set in the lane [3], and both of the flags cu2 and co2 are set in the lane [3]. As a result, the lane [3] outputs the clear signal CL4 to the termination logic 20c, and the same clear signal CL4 is input to the termination logic 20c.

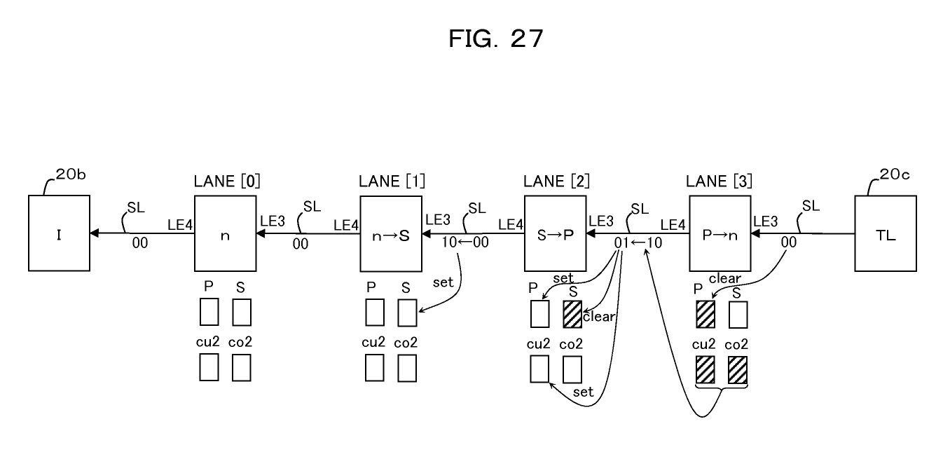

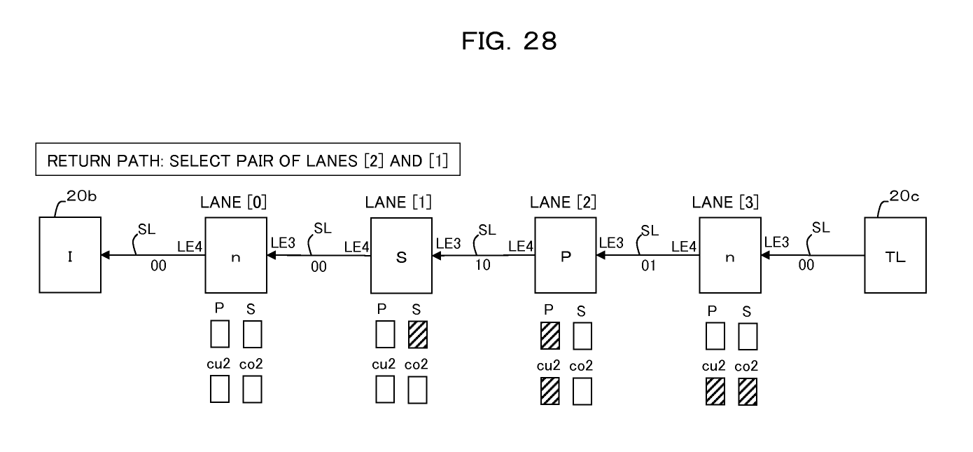

In the operations (17) and (18) illustrated in FIGS. 27 and 28, when the termination logic 20c receives the clear signal CL4 from the lane [3], the lane enable signal LE3[1:0] input from the termination logic 20c to the lane [3] changes from “01” to “00”. As a result, the flag P of the lane [3] is cleared. Further, as both of the flag cu2 and the flag co2 are set in the lane [3] in the operation (16), the lane enable signal LE3[1:0] input from the lane [3] to the lane [2] changes from “10” to “01”. When the lane enable signal LE3[1:0]=“01” is input to the lane [2], the flags P and cu2 are set in the lane [2], the flag S is cleared, and the lane enable signal LE3[1:0] input from the lane [2] to the lane [1] changes from “00” to “10”. When the lane enable signal LE3[1:0]=“10” is input to the lane [1], the flag S is set in the lane [1]. As a result, the lane [3] is deactivated, and a lane pair having the lane [2] as a primary lane and the lane [1] as a secondary lane is selected as illustrated in FIG. 28.

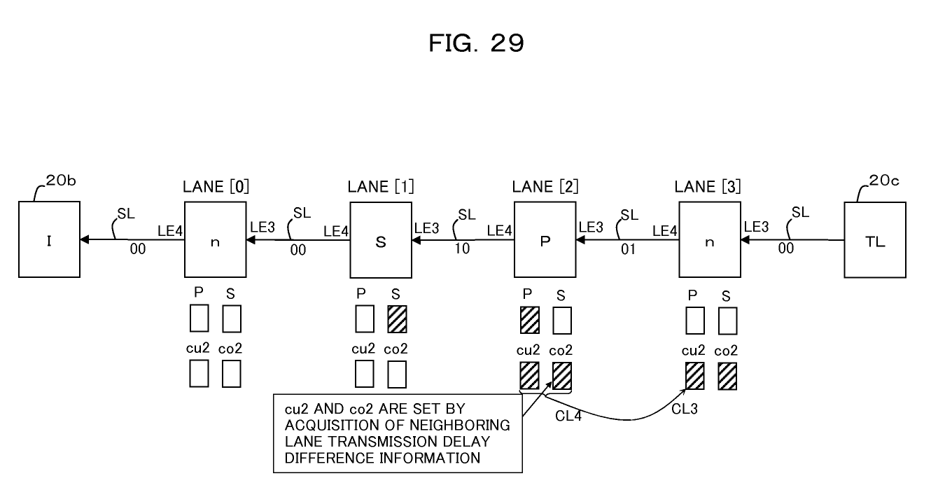

In the operation (19) illustrated in FIG. 29, when the lanes [2] and [1] receive the neighboring lane transmission delay difference information from each other after the operation (18), that is, when the primary lane [2] completes the setting process in the return path, the flag co2 is set in the lane [2], and both of the flags cu2 and co2 are set in the lane [2]. As a result, the lane [2] outputs the clear signal CL4 to the lane [3], and the same clear signal CL4 is input as the clear signal CL2 of the lane [3].

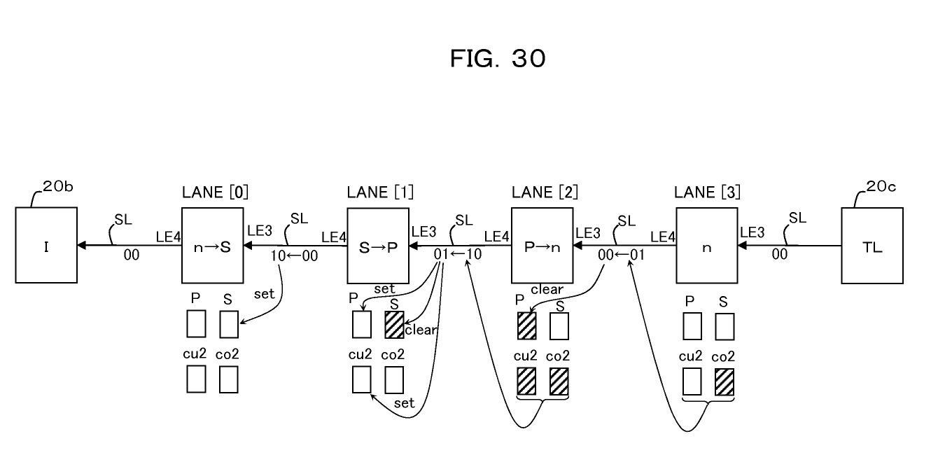

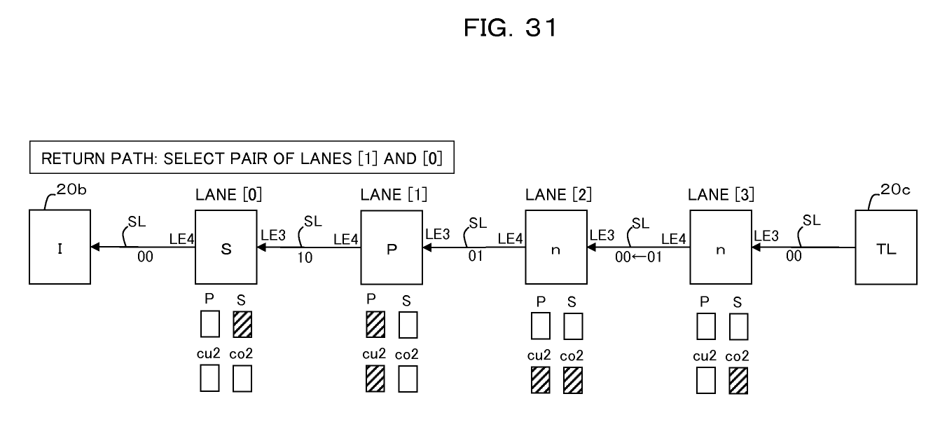

In the operations (20) and (21) illustrated in FIGS. 30 and 31, when the lane [3] receives the clear signal CL3 from the lane [2], the flag cu2 of the lane [3] is cleared. According to this operation, the lane enable signal LE3[1:0] input from the lane [3] to the lane [2] changes from “01” to “00”. As a result, the flag P of the lane [2] is cleared. Further, as both of the flags cu2 and co2 are set in the lane [2] in the operation (19), the lane enable signal LE3[1:0] input from the lane [2] to the lane [1] changes from “10” to “01”. When the lane enable signal LE3[1:0]=“01” is input to the lane [1], the flags P and cu2 are set in the lane [1], the flag S is cleared, and the lane enable signal LE3[1:0] input from the lane [1] to the lane [0] changes from “00” to “10”. When the lane enable signal LE3[1:0]=“10” is input to the lane [0], the flag S is set in the lane [0]. As a result, the lane [2] is deactivated, and a lane pair having the lane [1] as a primary lane and the lane [0] as a secondary lane is selected as illustrated in FIG. 31.

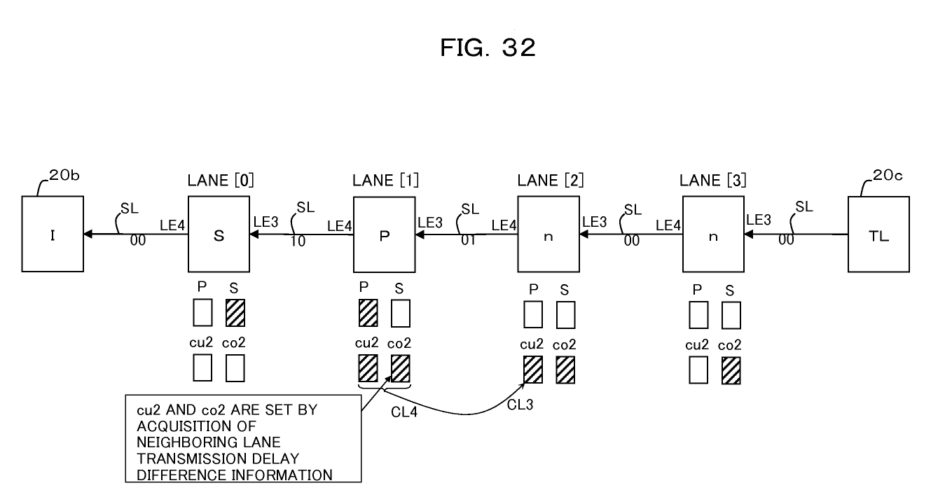

In the operation (22) illustrated in FIG. 32, when the lanes [1] and [0] receive the neighboring lane transmission delay difference information from each other after the operation (21), that is, when the primary lane [1] completes the setting process in the return path, the flag co2 is set in the lane [1], and both of the flags cu2 and co2 are set in the lane [1]. As a result, the lane [1] outputs the clear signal CL4 to the lane [2], and the same clear signal CL4 is input as the clear signal CL3 of the lane [2].

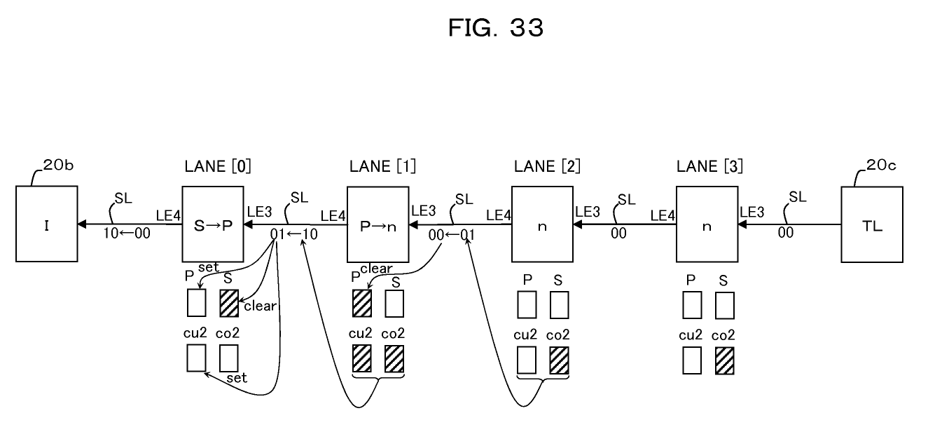

In the operations (23) and (24) illustrated in FIGS. 33 and 34, when the lane [2] receives the clear signal CL3 from the lane [1], the flag cu2 of the lane [2] is cleared. According to this operation, the lane enable signal LE3[1:0] input from the lane [2] to the lane [1] changes from “01” to “00”. As a result, the flag P of the lane [1] is cleared. Further, as both of the flags cu2 and co2 are set in the lane [1] in the operation (22), the lane enable signal LE3[1:0] input from the lane [1] to the lane [0] changes from “10” to “01”. When the lane enable signal LE3[1:0]=“01” is input to the lane [0], the flags P and cu2 are set in the lane [0], the flag S is cleared, and the lane enable signal LE4[1:0] input from the lane [0] to the initialization state machine 20b changes from “00” to “10”.

Then, in the operation (24) illustrated in FIG. 34, when the initialization state machine 20b receives the lane enable signal LE4[1:0]=“10”, the initialization state machine 20b inputs the set signal SC2 for setting the flag co2 of the lane [0] to the lane [0] as the neighboring lane transmission delay information.

In the operation (25) illustrated in FIG. 35, when the lane [0] receives the set signal SC2 from the initialization state machine 20b, the flag co2 is set in the lane [0], and both of the flags cu2 and co2 are set in the lane [0]. As a result, the lane [0] outputs the clear signal CL4 to the lane [1], and the same clear signal CL4 is input as the clear signal CL3 of the lane [1].

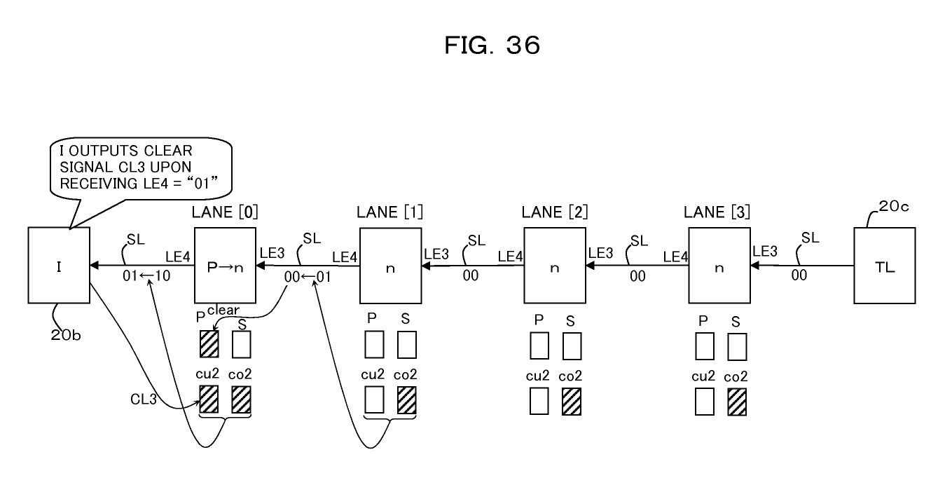

In the operation (26) illustrated in FIG. 36, when the lane [1] receives the clear signal CL3 from the lane [0], the flag cu2 of the lane [1] is cleared. According to this operation, the lane enable signal LE3[1:0] input from the lane [1] to the lane [0] changes from “01” to “00”. As a result, the flag P of the lane [0] is cleared. Further, as both of the flags cu2 and co2 are set in the lane [0] in the operation (25), the lane enable signal LE4[1:0] input from the lane [0] to the initialization state machine 20b changes from “10” to “01”. When the lane enable signal LE4[1:0]=“01” is input from the lane [0], the initialization state machine 20b inputs the clear signal CL3 to the lane [0].

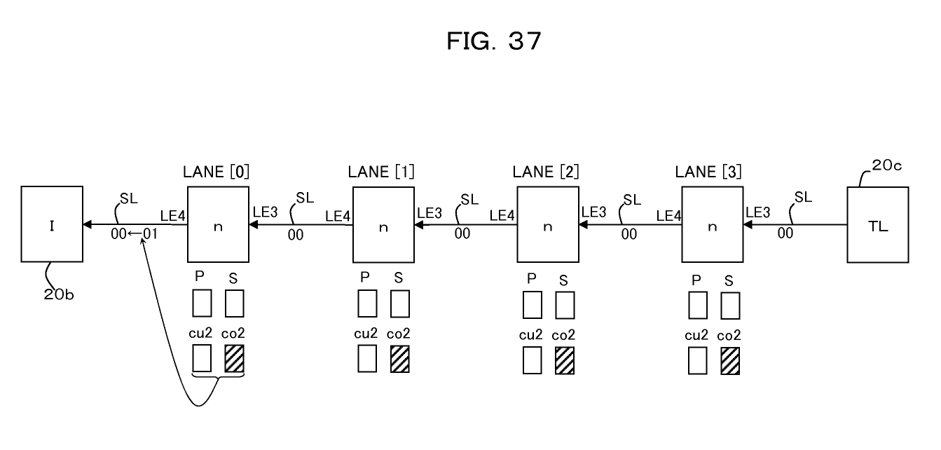

In the operation (27) illustrated in FIG. 37, when the lane [0] receives the clear signal CL3 from the initialization state machine 20b, the flag cu2 of the lane [0] is cleared. According to this operation, the lane enable signal LE3[1:0] input from the lane [0] to the initialization state machine 20b changes from “01” to “00”, and then the lane pair selection operation in the return path is completed.

Through the above-described process, a series of lane pair selection operations, that is, the inter-lane transmission delay difference absorption setting process is completed.

According to the transmission delay difference absorbing device (communication device), the information related to the transmission delay difference absorption setting process (transmission delay difference) is collected while sequentially shifting and selecting a lane pair through the pattern detecting circuit 25 and the control circuit 26 (the lane control unit 26b) in the lanes connected in the beaded form. Then, based on the collected information, the setting process is performed such that the control circuit 26 of a lane which is smaller in a transmission delay difference in the lane pair adjusts the data read-out timing of its own inter-lane transmission delay difference absorbing buffer 24 to that of the buffer 24 of a lane which is larger in the transmission delay difference.

At this time, the setting process is performed not only in the outward path while shifting a lane pair from the lane [0] to the lane [n] but also in the return path while shifting a lane pair from the lane [n] to the lane [0]. In this manner, by reciprocating the setting process once, it is possible to reliably prevent the setting process from ending in the state in which the lane [0] receives data earlier than the other lanes [1] to [3] by a 1 clock, for example, as illustrated in FIGS. 10D to 10F.

Thus, according to the present embodiment, information is not collected in a single control circuit as in the related art, and the setting process of the read pointer is reliably performed such that a transmission delay difference of all the lanes [0] to [n] is absorbed. Accordingly, even when the number of lanes of a processing target increases, as the lanes are connected to one another in the beaded form (in series), the setting process can be performed on all lanes, and the setting process of correcting the transmission delay difference between lanes can be reliably performed while implementing an interconnection layout, a noise counter-measure, and a high-speed circuit.

[3] Others

The preferable embodiment of the present invention has been described above in detail, but the present invention is not limited to a specific relevant embodiment, and various modification and changes can be made within the scope not departing from the gist of the present invention.

For example, in the concrete example of the embodiment described above with reference to FIGS. 10 to 37, the number of lanes is 4, but the present invention is not limited to this example.

In the technology of the disclosure, even when the number of lanes of a processing target increases, the setting process of correcting the transmission delay difference (correction process) can be reliably performed while implementing an interconnection layout, a noise counter-measure, and a high-speed circuit.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment (s) of the present invention has (have) been described in detail, it should be understood that the various changes, substitutions, and alterations could be made hereto without departing from the spirit and scope of the invention.

What is claimed is:

1. A transmission delay difference correction method of correcting a transmission delay difference in a plurality of transmission paths in a communication device that comprises a plurality of receiving units each corresponding to one of the plurality of transmission paths and that receives data from a transmission side device through the plurality of transmission paths, wherein each of the plurality of receiving units is connected to each neighboring receiving unit via a signal line, the transmission delay difference correction method comprising:
at two neighboring receiving units among the plurality of receiving units, the two neighboring receiving units receiving a same signal;
upon receipt of the same signal at each neighboring receiving unit, notifying the other neighboring receiving unit of the receipt of the same signal through the signal line;
at the each neighboring receiving unit, performing a process of correcting the transmission delay difference according to a time difference between notification of the receipt of the same signal from the other neighboring receiving unit and the receipt of the same signal at the each neighboring receiving unit;
performing a process of selecting, as next two neighboring receiving units, one of the two neighboring receiving units and a receiving unit, neighboring to the one receiving unit, that has not performed the process of correcting with the one receiving unit, among the plurality of receiving units; and
performing the process of correcting for the selected next two neighboring receiving units.

2. The transmission delay difference correction method according to claim 1, further comprising:
sequentially selecting the two neighboring receiving units until reaching from a receiving unit of one end to a receiving unit of the other end in the plurality of receiving units, and performing the process of correcting for the selected two neighboring receiving units each time the two neighboring receiving units are selected; and then
sequentially selecting the two neighboring receiving units until reaching from the receiving unit of the other end to the receiving unit of the one end in the plurality of receiving units that have performed the process of correcting, and performing the process of correcting for the selected two neighboring receiving units again each time the two neighboring receiving units are selected.

3. A communication device that is connected to a transmitting device through a plurality of transmission paths and that receives information from the transmitting device through the plurality of transmission paths, the communication device comprising:
a plurality of receiving units each of which is provided for each transmission path; and
a signal line that connects each of the plurality of receiving units to each neighboring receiving unit;
wherein each of the plurality of receiving units comprises
a detecting unit that detects a signal received through a corresponding transmission path of the plurality of transmission paths, and transfers and receives a detection result of the signal to and from a neighboring receiving unit to each receiving unit of the plurality of receiving units through the signal line, and
a control unit that performs control such that a transmission delay difference between each receiving unit and the neighboring receiving unit is corrected based on a detection time difference between a timing of detecting the signal at the neighboring receiving unit and a timing of detecting the signal at each receiving unit, and
the control unit notifies the neighboring receiving unit of a state of a process of correcting at each receiving unit, and when the control unit has not performed the process of correcting, the control unit starts the process of correcting in response to notification of the state of the process of correcting from the neighboring receiving unit.

4. The communication device according to claim 3,
wherein the control unit
is in collaboration with the neighboring receiving unit,
sequentially selects two neighboring receiving units until reaching from a receiving unit of one end to a receiving unit of the other end in the plurality of receiving units, and performs the process of correcting for the selected two neighboring receiving units each time the two neighboring receiving units are selected; and then
sequentially selects the two neighboring receiving units until reaching from the receiving unit of the other end to the receiving unit of the one end in the plurality of receiving units that have performed the process of correcting, and performs the process of correcting for the selected two neighboring receiving units again each the time two neighboring receiving units are selected.

5. The communication device according to claim 4,
wherein the control unit comprises
a buffer that temporarily holds a plurality of pieces of data from the transmitting device,
a pattern detecting unit that detects data having a specific pattern from the transmitting device when the process of correcting is performed,
a transmission delay difference detecting unit that detects the transmission delay difference between each receiving unit and the neighboring receiving unit based on a timing of detecting the specific pattern by the pattern detecting unit and a timing of detecting the specific pattern by the neighboring receiving unit which is received through the signal line when the process of correcting is performed, and
a buffer control unit that sets a read-out position of the data from the buffer such that the transmission delay difference detected by the transmission delay difference detecting unit is absorbed.

6. The communication device according to claim 4,
wherein the control unit
comprises a buffer that temporarily holds a plurality of pieces of data from the transmitting device, and
changes a read-out position of the data from the buffer when a timing of receiving the signal by each receiving unit is later than a timing of receiving the signal by the neighboring receiving unit.

7. The communication device according to claim 5,
wherein the buffer control unit
sets the read-out position of the data from the buffer such that a value corresponding to the transmission delay difference is absorbed, a value being obtained by adding a first transmission delay difference detected by the transmission delay difference detecting unit until selection of the two neighboring receiving units reaches from the receiving unit of one end to the receiving unit of the other end in the plurality of receiving units to a second transmission delay difference detected by the transmission delay difference detecting unit until selection of the two neighboring receiving units reaches from the receiving unit of the other end to the receiving unit of the one end in the plurality of receiving units.

8. The communication device according to claim 5,
wherein the control unit comprises a lane control unit that is in collaboration with the control unit disposed in the neighboring receiving unit,
the lane control unit
sequentially selects the two neighboring receiving units until reaching from the receiving unit of one end to the receiving unit of the other end in the plurality of receiving units, and causes the pattern detecting unit, the transmission delay difference detecting unit, and the buffer control unit to perform a process of setting the read-out position each time the two neighboring receiving units are selected, and
sequentially selects the two neighboring receiving units until reaching from the receiving unit of the other end to the receiving unit of the one end in the plurality of receiving units that have performed the process of setting, and causes the pattern detecting unit, the transmission delay difference detecting unit, and the buffer control unit to perform the process of correcting for the selected two neighboring receiving units again each time the two neighboring receiving units are selected.

9. The communication device according to claim 7,
wherein the control unit comprises a lane control unit that is in collaboration with the control unit disposed in the neighboring receiving unit,
the lane control unit
sequentially selects the two neighboring receiving units until reaching from the receiving unit of one end to the receiving unit of the other end in the plurality of receiving units, and causes the pattern detecting unit, the transmission delay difference detecting unit, and the buffer control unit to perform a process of setting the read-out position each time the two neighboring receiving units are selected, and
sequentially selects the two neighboring receiving units until reaching from the receiving unit of the other end to the receiving unit of the one end in the plurality of receiving units that have performed the process of setting, and causes the pattern detecting unit, the transmission delay difference detecting unit, and the buffer control unit to perform the process of correcting for the selected two neighboring receiving units again each time the two neighboring receiving units are selected.

10. A communication system, comprising:
a transmitting device; and
a communication device that is connected to the transmitting device through a plurality of transmission paths and that receives information from the transmitting device through the plurality of transmission paths,
wherein the communication device comprises
a plurality of receiving units each of which is provided for each transmission path, and
a signal line that connects each of the plurality of receiving units to each neighboring receiving unit, and
each of the plurality of receiving units comprises
a detecting unit that detects a signal received through a corresponding transmission path of the plurality of transmission paths, and transfers and receives a detection result of the signal to and from a neighboring receiving unit to each receiving unit of the plurality of receiving units through the signal line, and
a control unit that performs control such that a transmission delay difference between each receiving unit and the neighboring receiving unit is corrected based on a detection time difference between a timing of detecting the signal at the neighboring receiving unit and a timing of detecting the signal at each receiving unit, and
the control unit notifies of the neighboring receiving unit of a state of a process of correcting at each receiving unit, and when the control unit has not performed the process of correcting, the control unit starts the process of correcting in response to notification of the state of the process of correcting from of the neighboring receiving unit.

11. The communication system according to claim 10,
wherein the control unit
is in collaboration with the neighboring receiving unit,
sequentially selects two neighboring receiving units until reaching from a receiving unit of one end to a receiving unit of the other end in the plurality of receiving units, and performs the process of correcting for the selected two neighboring receiving units each time the two neighboring receiving units are selected; and then
sequentially selects the two neighboring receiving units until reaching from the receiving unit of the other end to the receiving unit of the one end in the plurality of receiving units that have performed the process of correcting, and performs the process of correcting for the selected two neighboring receiving units again each time the two neighboring receiving units are selected.

12. The communication system according to claim 11,
wherein the control unit comprises
a buffer that temporarily holds a plurality of pieces of data from the transmitting device,
a pattern detecting unit that detects data having a specific pattern from the transmitting device when the process of correcting is performed,
a transmission delay difference detecting unit that detects the transmission delay difference between each receiving unit and the neighboring receiving unit based on a timing of detecting the specific pattern by the pattern detecting unit and a timing of detecting the specific pattern by the neighboring receiving unit which is received through the signal line when the process of correcting is performed, and
a buffer control unit that sets a read-out position of the data from the buffer such that the transmission delay difference detected by the transmission delay difference detecting unit is absorbed.

13. The communication system according to claim 11,
wherein the control unit
comprises a buffer that temporarily holds a plurality of pieces of data from the transmitting device, and
changes a read-out position of the data from the buffer when a timing of receiving the signal by each receiving unit is later than a timing of receiving the signal by the neighboring receiving unit.

14. The communication system according to claim 11,
wherein the buffer control unit
sets a read-out position of the data from the buffer such that a value corresponding to the transmission delay difference is absorbed, a value being obtained by adding a first transmission delay difference detected by the transmission delay difference detecting unit until selection of the two neighboring receiving units reaches from the receiving unit of one end to the receiving unit of the other end in the plurality of receiving units to a second transmission delay difference detected by the transmission delay difference detecting unit until selection of the two neighboring receiving units reaches from the receiving unit of the other end to the receiving unit of the one end in the plurality of receiving units.

15. The communication system according to claim 12,
wherein the control unit comprises a lane control unit that is in collaboration with the control unit disposed in the neighboring receiving unit,
the lane control unit
sequentially selects the two neighboring receiving units until reaching from the receiving unit of one end to the receiving unit of the other end in the plurality of receiving units, and causes the pattern detecting unit, the transmission delay difference detecting unit, and the buffer control unit to perform a process of setting the read-out position each time the two neighboring receiving units are selected, and
sequentially selects the two neighboring receiving units until reaching from the receiving unit of the other end to the receiving unit of the one end in the plurality of receiving units that have performed the process of setting, and causes the pattern detecting unit, the transmission delay difference detecting unit, and the buffer control unit to perform the process of correcting for the selected two neighboring receiving units again each time the two neighboring receiving units are selected.

16. The communication system according to claim 14,
wherein the control unit comprises a lane control unit that is in collaboration with the control unit disposed in the neighboring receiving unit,
the lane control unit
sequentially selects the two neighboring receiving units until reaching from the receiving unit of one end to the receiving unit of the other end in the plurality of receiving units, and causes the pattern detecting unit, the transmission delay difference detecting unit, and the buffer control unit to perform a process of setting the read-out position each time the two neighboring receiving units are selected, and
sequentially selects the two neighboring receiving units until reaching from the receiving unit of the other end to the receiving unit of the one end in the plurality of receiving units that have performed the process of setting, and causes the pattern detecting unit, the transmission delay difference detecting unit, and the buffer control unit to perform the process of correcting for the selected two neighboring receiving units again each time the two neighboring receiving units are selected.
